(19) United States
(12) Patent Application Publication
(10) Pub. No.: US 2025/0226120 A1
(43) Pub. Date: Jul. 10, 2025

(54) Reactor For Energy Generation By Nuclear Fusion

(71) Applicant: Avner Rosenberg, Bet Shearim (IL)

(72) Inventor: Avner Rosenberg, Bet Shearim (IL)

(21) Appl. No.: 18/700,306

(22) PCT Filed: Jan. 29, 2023
(86) PCT No.: PCT/IL2023/050096

§ 371 Date: Apr. 11, 2024

(30) Foreign Application Priority Data
Mar. 13, 2022 (IL) 291313

(51) Int. Cl. G21B 3/00

(52) U.S. Cl. CPC G21B 3/008

(57) ABSTRACT

A fusion reactor for energy generation by creation of hot and dense plasma suitable for nuclear fusion, including: a high pressure tank defining the external boundary of at least part of a first volume; a solid barrier defining at least part of the boundary between the first volume and a second volume; liquid in a reservoir; at least one pump configured to deliver said liquid from said reservoir into the first volume and to compress it to high pressure in the first volume; fusionable material filling at least part of the second volume; means configured to make said solid barrier penetrable to liquid, allowing liquid flow from the first volume into the second volume.

### FIELD OF THE INVENTION

The generation and compression of hot and dense plasma is particularly useful for energy generation by nuclear fusion.

### BACKGROUND OF THE INVENTION

Fusion of light nuclei to heavier ones is considered by the scientific community to be the future source of energy for mankind. The fuel may be Hydrogen isotopes, for example, Deuterium, which can be extracted from water. The fusion process is carbon emission-free, and the fusion outcomes are not environmentally hazardous.

The leading process for fusion is the generation of hot dense plasma. For obtaining a significant number of fusion events, plasma temperature must be higher than 1 keV, better higher than 10 keV (about 100 million degrees Kelvin). The density must be high to provide enough fusion reactions. The Lawson criterion sets a minimum requirement on the plasma density times the plasma confinement time, known as [nτ], so that the energy output from the fusion reaction in the plasma is larger than the energy delivered into the plasma. For Deuterium-Tritium (DT) at optimal temperature nτ must be larger than 10²⁰[m⁻³ sec], and for Deuterium-Deuterium (DD) nτ must be larger than 10²²[m⁻³ sec]. The race for establishing fusion as a viable energy source is few decades-long with investment of billions of Dollars. Although huge progress was achieved, the goal seems now to be at least a decade ahead. The most invested technologies are magnetic confinement fusion (MCF) and Inertial Confinement Fusion (ICF). The largest MCF project is ITER—International Thermonuclear Experimental Reactor, a multinational effort based on Tokamak (Torus) configuration. It is a huge and very expensive facility, and even if successful in delivering net energy it is doubtful if it can be a commercial solution for a power station. One must be careful not to confuse “plasma energy gain” or “ignition” with “net energy delivery”: The first relates to the energy output of the plasma compared to that invested in the plasma; the second considers the overall efficiency of the facility. The Tokomak requires extremely high magnetic fields in a large volume, which require a lot of energy.

Huge magnetic fields are used to confine and compress plasma. Static (DC) magnetic fields are produced by large superconductor electromagnets, which are very expensive and consume a lot of energy. Pulsed magnetic field may be produced by non-superconducting coils, but a lot of energy from a capacitor bank is required, most of it lost as heat.

A review of alternative fusion energy approaches was written by Derek A. Sutherland from CTFusion Inc. dated Jun. 18, 2020, presented at “Introduction to Fusion Energy and Plasma Physics SULI 2020” https://suli.pppl.gov/2020/course/pppl_suli_presentation_final.pdf.

There is a class of magnetically confined plasmas, where a pulsed current of hundreds of kA up to a few MA range is injected directly into the plasma and generate huge magnetic field which confines and compress the plasma. For example, what is known as Z-pinch plasma, where the current is axial (Z-axis) and generate an azimuthal magnetic field. This technology is considered to belong to a class of “medium scale” reactors, referring to the physical size of the system and the cost of building it.

Another multi-billion project is the leading inertial confinement fusion—ICF project, known as NIF. NIF—National Ignition Facility, in the USA. It is based on focusing intense laser arrays on a few millimeters pellet which is compressed for a short time to extremely high density and temperature. The published numbers (2021) (from https://lasers.llnl.gov) exemplifies the energy gain issue: About 400 MJ are released each pulse. From this huge energy, only 2.15 MJ are delivered to the pellet. The fusion output is 1.3 MJ. It is considered close to ignition or “breakeven”, which will be achieved if more than 2.15 MJ obtained from the fusion processes. Even so, it is only half a percent of the primary invested energy, so the way for a power plant is very long. Comparing Tokomak to laser ICF, the Tokomak produces relatively low-density plasma for a long time (many seconds), while the laser ICF is at the other end of the scale—very dense plasma lasting for a short time (microseconds).

In 2014 the US Government launched a program named ARPA-E, which supported 9 (nine) selected R&D programs intended to develop a medium size and cost fusion reactors. Status review from 2019 can be found in 1907.09921.pdf (arxiv.org). The program includes technologies like Sheared-Flow Z-Pinch, Magnetic Compression of Field Reversed Configuration (FRC) Targets, Staged Z-Pinch Target and Stabilized Liner Compressor. The relevant ones will be discussed later in more detail.

The search for better ways to generate fusion is also active in universities and in the private sector. Only few technologies which were started survived the difficulties and are in business today. A recent review was published in IEEE spectrum, 28 Jan. 2020 (https://spectrum.ieee.org/5-big-idweas-for-making-fusion-power-a-reality). It does not necessarily mean that the technologies of startups which were discontinued are not viable. Fusion projects are long-distance running, the required time and money for even the first step of proof of concept is very large, so even excellent ideas might be discontinued due to management and financial issues.

“Sonofusion” was conceived as a tabletop alternative to induce fusion. Sonofusion is a name given to the generation of high-density high-temperature plasma during the implosion of a bubble under the pressure of an ultrasound wave in liquid. The process of bubble formation in liquid is called cavitations. The idea of using this process for fusion was based on a phenomenon discovered long ago, named sonoluminescence.

During bubble implosion a short burst of light was observed, indicating the creation of high-temperature plasma. While spectroscopic measurements gave indication for temperatures of the order of 10⁴K, theories predicted that under optimal conditions 10⁷K may be achieved. It was also claimed that dense plasma might attenuate emissions from the central hot spot, so the real temperature may be higher than that measured by spectroscopic ways.

U.S. Pat. No. 4,333,796 filed on May 19, 1978, discloses fusion generation in bubbles created in metal liquid. The advantages of using metal liquid are discussed in this patent. The metal has very low vapor pressure, therefore during the expansion phase of the bubble, the liquid vapor stays a minority inside the bubble, leaving most of the bubble volume for the fusionable gas (D2, or D2+T2). The metal liquid has low compressibility compared to other liquids (water, glycerin, acetone, . . . ). Low compressibility is important during the final stage of the bubble implosion when the pressure in the gas-liquid boundary is extremely high. With low compressibility, less energy is lost in the liquid. Building large bubbles from seeds in the liquid requires negative pressure for a long time. In the final compression stage, the acceleration of the liquid is outwards, stabilizing the bubble. The inventor of U.S. Pat. No. 4,333,796 suggests to apply magnetic field to balance the force of gravity which might make the bubble asymmetric. Unfortunately, this patent includes no data on expected pressures and temperatures in the bubble at the maximum of the implosion.

A paper published in 1996 (Physics Letters A 2 11 (1996), 69-74) contains a theoretical calculation of cavitations in water under ultrasound with a peak pressure of 1 (one) Bar, superposed by a pressure pulse at the bubble collapse of 5 (five) Bar. The calculated temperature at the center of the bubble was more than 2 keV. However, the inventor could not find experimental results supporting such a high temperature.

In 2002 Rusi Taleyarkhan et. al. published a paper named “Evidence for nuclear emissions during acoustic cavitation”, Science, Vol. 295, pp. 1868-1872 (2002), claiming for experimental detection of fusion reactions in cavitations formed in D-acetone (Acetone with Deuterium replacing the Hydrogen ¹H) with a tabletop ultrasound system. Also disclosed in patent application US20050135532A1. Such a tabletop system capable of making fusion seems like a huge breakthrough. However, the scientific community was very skeptical. During the following decade, a large dispute aroused. The mainstream scientists do not trust these results. It is not the place to judge; however, even if fusion events occurred in the reported experiments, the parameters are very far from satisfying Lawson criterion, so very large enhancement is required to make it a candidate for a fusion energy generator.

One way for the generation of more intense bubbles implosion is to add static pressure to the alternating ultrasound wave. Published research at Ultrasonics, Volume 65, February 2016, Pages 380-389, contain theoretical and experimental results with static pressures in heavy water (D₂O) up to 30 MPa (300 Bar) and in liquid metal up to 150 MPa (1.5 kBar). With 20 MPa pressure, bubble temperatures at implosion above 100,000K (about 10 eV) were measured. It is yet 3 orders of magnitudes less than the 10 keV which is optimal for D-T fusion. However, it is claimed in few publications that the plasma might screen spectral lines so that the real temperature may be higher. Also, calculations predict a possible increase of temperature with the increase of liquid pressure. Peak pressure in the bubble at maximum contraction is estimated as 250 GPa (2.5 MBar). The experimental system used was developed by a company named “Impulse Devices Inc.” (later “Burst Laboratories Inc.” 13366 Grass Valley Ave Ste H, Grass Valley, CA 95945-9549, USA).

It is important to understand that a necessary condition for efficient compression is that the bubble starts from a large radius and compressed by the liquid to a small radius. When combining ultrasound wave pressure and static pressure, the maximum bubble radius depends on the sum of the static pressure and the negative pressure peak of the ultrasound wave, while the compression radius depends on the sum of the static pressure and the peak positive pressure of the ultrasound wave. Therefore, the bubble compression is dependent on the peak to peak pressure amplitude of the ultrasound wave. This means that for a symmetrical ultrasound wave the gain achieved by adding a static pressure is limited to a factor of two. The conclusion is that the maximum performance depends on the intensity of the ultrasound wave and cannot be increased further just by increasing the static pressure. The peak-to-peak ultrasound amplitude must be increased to improve bubbles implosion. This is a major drawback since it is difficult to generate high intensity ultrasound, while very high static pressure can be achieved by on-the-shelf equipment.

U.S. Pat. No. 7,547,133B2 discloses bubble generation and implosion driven by hydraulic pressure. The hydraulic pressure in a liquid is produced by a piston-based driver. The assumption is that this may generate a more intense implosion accompanied by higher plasma temperature and density. The bubbles are formed from the liquid during a negative pressure phase and implode during a positive pressure phase. The fusionable material is extracted from the liquid during the negative pressure phase. This is a major drawback since the fusionable material composition in the bubble and the bubble initial size are not fully controlled. It also limits the type of liquid which can be used and dictates a very strict process of preparing a liquid with immersed fusionable gas. Another disadvantage is that the hydraulic pressure must be matched to the bubble dynamics in the following way: First the hydraulic pressure must be reduced to bring the bubble to large radius, then the pressure must be increased to compress the bubble. The transition from low to high pressure must be fast, as fast as the bubble compression time. This requirement is difficult to fulfill with such an hydraulic system, therefore bubble compression is limited. U.S. Pat. No. 10,002,680B2, assigned to General Fusion Inc. discloses a “pressure wave” acting on a bubble. Bubbles are injected in the lower part of a liquid and moving upwards due to buoyancy. Bubble locating system reports the bubble position for synchronizing a pressure wave which converges on the bubble. The patent discloses forming of pressure wave by a plurality of wave generators. Each wave generator includes a piston accelerated and impinged on a transducer. Spherical arrangement and timing means are used for making the pressure wave spherical, converging on the injected bubble. Note the difference from the previous patent, U.S. Pat. No. 7,547,133B2, which discloses a piston which generates hydraulic pressure rise and fall in a liquid—but not a pressure wave. The major difference between the disclosed methods is the rise time of the pressure on the bubble. The “pressure wave” is claimed to solve one disadvantage of the hydraulic system (disclosed in U.S. Pat. No. 7,547,133B2) by making fast rise of the pressure on the bubble, hopefully matching bubble implosion time. However, it has few drawbacks, including: The need for pressure wave generators which might be inefficient; issue of timing to make sure the wave is concentrated symmetrically on the bubble; and expected multiple reflections in the liquid container which might damage the symmetry of the pressure on the bubble. Also, the pressure wave decays fast, therefore bubble oscillations cannot exist. Bubble oscillations can increase compression and compression time and so helpful for exceeding the Lawson criterion.

Research done by Smorodov E. A. and Galiahmetov R. N., published in Russian, whose translation can be found in http://nuclearfusion.narod.ru/esmorod.htm (2006), describes another approach to produce intense cavitations. Into a container filled with degassed glycerin a deuterium bubble was launched form the lowest end. The bubble size was 3 to 8 mm. Then the pressure in the liquid was quickly raised by dropping a heavy weight on a piston at the upper end of the container. The authors claimed to observe neutron emission correlated with the energy delivered to the piston by the weight. This method provides pressure rise faster than the hydraulic one mentioned above, but slower than the “pressure wave” disclosed in U.S. Pat. No. 10,002,680B2.

This principle was adopted by a company named Quantum Potential (later Quantum Fusion), in a paper published in 2012 (arXiv:1209 2407v1 [physics.gen-ph]). They claim to measure pressure of 300-500 Bar in the container and claimed to observe neutrons in the first 3 shots only. They assumed the vessel was damaged after few shots, not allowing the pressure to rise to the required level.

Quantum Potential technology seems to relax the strict requirement of the “pressure wave” (disclosed in U.S. Pat. No. 10,002,680B2) and makes improvement over the hydraulic pressure (disclosed in U.S. Pat. No. 7,547,133B2) by creating a fast pressure rise in the high pressure tank containing the liquid. The disadvantage is that it is not fast enough as the claimed “pressure wave” and cannot be delivered in a converging symmetrical way as disclosed in U.S. Pat. No. 10,002,680B2, so it might be too slow to match the bubble dynamics; on the other hand, it is not slow enough as the hydraulic pressure disclosed in U.S. Pat. No. 7,547,133B2 to ensure uniformity and symmetry of pressure around the bubble. Slow rising pressure might not match bubble compression time and reduce compression efficiency. Asymmetric pressure on the bubble might cause destructive bubble explosion (formation of jets) before reaching maximum compression.

General Fusion has been active for the last two decades in developing fusion reactors. They started with the idea of shock compression of a single bubble, similar to the scheme disclosed in U.S. Pat. No. 10,002,680B2.

In a presentation from 2012, the system and experimental results are depicted (https://www.slideserve.com/dallon/d-d-fusion-neutrons-from-a-strong-spherical-shock-wave-focused-on-a-deuterium-bubble-in-water). Spherical converging shock was generated in a liquid by exploding foils and was focused on a 6 mm Deuterium bubble. Neutron detection was claimed, indicative of fusion processes. In the following years General Fusion Inc. has focused on another technological path, combining magnetically confined plasma with a mechanical pressure. Note, for example, U.S. Pat. No. 10,092,914B2 and patent U.S. Pat. No. 10,811,144B2. The last one discloses a coaxial plasma generator, driven by a large current pulse from a capacitor bank. The plasma is confined and pushed along the coaxial structure by the magnetic fields generated by the plasma current and by external coils. The plasma is driven into a liner, made of liquid metal, then the plasma is further compressed by a pressure wave applied on the liquid metal liner. In the company publication site the latest technology is described (https://generalfusion.com/technology-magnetizied-target-fusion). The metal liner is pushed inwardly by a plurality of pistons driven by compressed gas. Hydraulic pressure is generated by pistons acting directly on the liquid metal, effecting mass flow of the liquid. This is different from the “pressure wave” disclosed in U.S. Pat. No. 10,002,680B2, which is a wave (sometimes called a shock wave) moving through the metals (solid and liquid).

The method of compressing plasma by mechanical action on surrounding liquid metal is also depicted in other patents and publications. U.S. Pat. No. 4,269,658, filed Feb. 14, 1977, assigned to General Atomic inc., discloses metal liquid rotating inside cylindrical bore. Axial magnetic field is formed by external coils. The rotation creates a cylindrical empty region inside the metal liquid, where plasma is formed. The metal liquid is compressed by an array of moveable wall members, compressing with it the magnetized plasma. A paper “Stabilized Liner Compressor for Low-Cost Controlled Fusion at Megagauss Field Levels” (published in IEEE Transactions on Plasma Science, June 2017, p. 99 (DOI: 10.1109/TPS.2017.2702625)) describes a scheme of combined magnetic and mechanical plasma compression. Liquid metal is rotated to create a clear central (axial) bore. In the scheme depicted in FIG. 6 of this publication, the whole chamber is rotated to create the liquid rotation. It is claimed that container rotation is more efficient than side injection since viscosity losses are reduced. This liquid metal is called “liner”. The container with the rotating liquid is immersed in a strong axial magnetic field created by external coils. Plasma is injected into the empty axial bore, then annular pistons driven by compressed gas push the liquid metal into the bore, thereby compressing the plasma to high temperature and high density, hopefully sufficient for ignition of the fusion process. Later on, this project will be referred to as NumerEX—the commercial name.

General Fusion and NumerEx technologies use mechanical compression on a plasma in addition to magnetic compression. The application of this mechanical compression energy seems helpful, and these projects are in progress. However, note that the mechanical energy is applied only in the last phase of the compression, after the plasma was already compressed by magnetic fields. The pressure on the metal liquid is driven from a near zero pressure state and applied only when the plasma is already inside the liner. The disadvantages are the slow rise of pressure and no contribution to the compression from the inertia of accelerated liquid similar to that exists in the bubble dynamics. The liquid is pushed against a plasma already compressed; therefore the plasma applies resisting outward force which prevents substantial acceleration of the liquid.

U.S. Pat. No. 9,524,802 discloses FRC (Field Reverse Configuration) plasma compressed by collapsing a metal shell about the FRC plasma. In one embodiment a generated magnetic field inductively collapses the metal shell of the FRC plasma to compress the FRC plasma to fusion conditions. Magnetic pressure is a valuable tool commonly used by plasma physicists, but requires large, expensive, and relatively inefficient pulsed power generators. Also, at high levels of magnetic compression various instabilities arise, which limit the performance.

Table 1 is intended to clarify the innovation and advantages of the present invention by summarizing the major relevant parameters of prior art. The table does not cover all fusion reactor variants and all technological aspects, and credit is not given to all published projects.

TABLE 1
Summary of most relevant parameters of prior art

| | Confinement/ | | | |
|---|---|---|---|---|
| | Compression | Class | Technology | Example |
| 1 | Magnetic | Steady | Superconducting | Tokamak |
| 2 | | Pulsed | External coils | Theta Pinch |
| 3 | | | Current in plasma | Z-pinch |
| 4 | Mechanical | Ultrasound | Transducers | Sonofusion |
| 5 | | Shock | Gas pistons, | General Fusion |
| | | Pressure | exploding foils | Inc. earlier |
| | | wave | | versions |
| 6 | | Pulsed | Pistons driven | Quantum |
| | | hydraulic | magnetically, by | Potential/ |
| | | pressure | compressed gas | Fusion |
| | | | or by falling | |
| | | | weight | |
| 7 | | Hybrid static | Pump and | Impulse |
| | | and | transducers | Devices Inc. |
| | | ultrasound | | |
| 8 | Hybrid | External | Rotating metal | NumerEX- SLC |
| | Magnetic and | magnetic | liquid, external | (Stabilized |
| | Mechanical | and liquid | magnetic field, | Liner |
| | | liner | plasma injected | Compressor) |
| | | | into an axial bore, | |
| | | | compressed gas | |
| | | | driven pistons | |
| | | | push the metal | |
| | | | liquid | |
| 9 | | Plasma | Pulsed current | General Fusion |
| | | current | plasma, piston | Inc. advanced |
| | | magnetic | pushing metal | project |
| | | field and | liquid liner | |
| | | liquid metal | | |
| | | liner | | |
| 10 | ICF | Laser | Laser | NIF |

Rows 1 and 10 in Table 1 refer to the high end in terms of size and money. Row 1 refers to huge and expensive superconducting electromagnets. The plasma is of low density but has a long confinement time. Row 10 refer to ICF—Inertial Confinement Fusion based on focusing an array of pulsed, high-power lasers on a millimeter-size fuel pellet. Extreme plasma densities are achieved but for a very short time. A major problem besides costs and size is the efficiency of the pulsed laser system.

All the other rows represent efforts in the middle range—moderate density lasting for adequate times.

Z-pinch technology is based on driving a very high axial current J (MA range) in a gas or in a conductive liner. The current J generates an azimuthal magnetic field B, the resulting J×B force compresses the plasma. In some embodiments external axial or azimuthal magnetic fields are added. While the Z-pinch is considered to be a promising path to compact fusion reactors, it has few major drawbacks: (a) Instabilities of the magnetic compression of the plasma. (b) Huge pulsed power system required for driving the MA level current, and the efficiency of this system is low. (c) All the energy invested in the magnetic field is lost at the end of the pulse.

Mechanical energy is, in general, cheaper and more efficient. Rows 4-7 are essentially bubble based—mechanical pressure on a gas bubble drives it to implosion, creating a dense hot plasma. The attractive tabletop ultrasound (row 4) seems to be too weak for reaching fusion conditions. Bubble compression by shock or pulsed hydraulic pressure (rows 5 and 6) was claimed to produce fusion neutrons, but it was not enough for continuing these projects, probably due to the marginal and unrepeatable results. Hybrid static and ultrasound (row 7) was shown in a scientific paper to produce higher temperature and density, but not enough for fusion [“Intense cavitation at extreme static pressure”, by Yuri A. Pishchalnikov et. al., Ultrasonics Volume 65, February 2016, Pages 380-389]. A drawback of this method, which probably limit the upscaling of the temperature and density, is that due to the static pressure, for the creation of the bubble, the ultrasound peak negative pressure must be at least equal to the static pressure. Also, the fact that the fusionable gas at the bubble must be drawn from the host liquid is a major drawback since it does not enable optimization of fusionable gas content and bubble size. The fusionable gas must be dissolved in the host liquid therefore limit the selection of host liquid. Also, the host liquid vapor might be mixed in an uncontrolled way with the fusionable gas. The projects of rows 8 and 9 are based on final compression of plasma by rotating liquid metal liner pushed mechanically by pistons. General Fusion project injects toroidal plasma formed by electrical discharge into a large bore of the liner.

NumerEX project inject plasma in an axial magnetic field. The justification of the use of mechanically driven pistons is that it is much more efficient than pulsed magnetic pressure. It is claimed that the energy density of compressed gas used for pushing the liner is much greater than that of the capacitor bank required for providing the huge currents required for magnetic compression.

### Physical Analysis:

As discussed above, using mechanical energy is more compact, efficient, and cheaper than pulsed electrical energy. It is an object of the present invention to disclose a better way to use mechanical energy for creation and/or compression of plasma.

The pure mechanical compression disclosed in prior art is based on bubble dynamics. Assume starting conditions of a gas bubble of radius R0 and pressure Pb inside a host liquid at pressure Pl, where Pl>>Pb. Due to the pressure difference the liquid will be accelerated towards the bubble center. This acceleration generates liquid flow directed to the center, thereby reducing bubble volume and accordingly increasing the gas pressure Pb inside the bubble. When the gas pressure inside the bubble becomes larger than the liquid pressure, the acceleration is inverted, directed outwards. The liquid mass flowing inwardly at high velocity continue to move by inertia, until stopped by this outward acceleration. This will happen at some minimum radius Rm. From that time the bubble will expand again until stopped when the liquid pressure is greater than the decreasing internal bubble pressure. This process can go on repeatedly.

Oscillatory bubbles contracting and expanding are observed if the proper conditions exist. First order theories assume adiabatic process, with no exchange of heat or materials between the liquid and the bubble. As noted in the review of prior art, it is advantageous to select host liquid materials and driving conditions which are closer to these approximations, since under these conditions bubble compression is more efficient.

It is important to emphasize the role of liquid inertia on imploding bubble dynamics: The momentum (and accordingly kinetic energy) gained by the liquid at the first stage of the implosion, when the pressure difference Pl-Pb is big, becomes very effective at the last stage of the compression when the internal gas pressure of the bubble is rising steeply and resist the inward flow of the liquid.

Due to the spherical symmetry of the process, the relative volume change is (R0/Rm)³. For example, for R0/Rm=10 the (ideal) compression ratio is 1000. This value is easily obtained in tabletop ultrasound in water. If R0/Rm=100, 10⁶ compression ratio will be obtained. This enormous compression is certainly useful for dense plasma creation and fusion reactions. However, this is an idealized description. As pioneers in this field found, there are practical reasons which limit the bubble compression performance.

The most important factor is the starting conditions of the bubble implosion. Ideally, it is best to start at maximum Pl−Pb pressure. Under these conditions, the inward acceleration is maximal. In the prior art review few ways for the creation and handling of bubbles were described, which can be divided into two major classes:
(a) Bubbles are formed from the host liquid during a negative pressure phase.
(b) A bubble is injected into the host liquid.

The use of “bubbles” vs. “a bubble” is intentional, since creation of bubbles from host liquid is not controlled—any number of bubbles can be created during the negative pressure phase. When injecting, the number of bubbles can be controlled.

Class (a) does not allow proper control of the gas content and size of the initial bubble, which is not desirable for fusion processes. It also limits the possible choice of host liquid. A critical performance limiting factor is that the bubble is at maximum radius at low or even negative pressure, therefore, the liquid must be driven very fast to high pressure to provide efficient compression of the bubble.

Class (b) relaxes some constrains related to the host liquid, however, fast pressure rise is required as before. Besides the inefficiency and complexity involved with generation of fast rising pressure, it is not optimal for high ratio bubble compression since the initial acceleration is low and part of the high pressure pulse might be too late to be effective for compression. In addition, the symmetry of the pressure on the bubble is crucial for high compression ratio. Asymmetry causes explosion of the bubble which may happen before the theoretically possible maximum compression. Such bubble explosion shortens the time of compression which is critical for fusion ignition (Lawson criterion). Additionally, it ruins the possibility of bubble oscillations which can be beneficial for fusion.

Under conditions of energy production in the bubble by nuclear fusion, energy is added to the bubble expansion. If the external host liquid pressure is kept constant, the bubble oscillations can grow, leading to more intense plasma and energy production. Fast rising pressure in the host liquid tends to produce waves which distorts the symmetry, therefore, limiting bubble compression and lifetime. In prior art reviews were included few configurations of a spherical converging pressure wave. This required accurate bubble location and exact focusing are difficult to achieve. Additionally, wave reflection from the bubble and supersonic shock waves might interfere with the desired bubble contraction. As found in the review of the prior art, these methods were tested and discarded later.

Hybrid mode, known as MIF—Magneto-Inertial Fusion is considered one of the promising fusion technologies. As described before, two major approaches are under development:
(a) General Fusion Inc. project—row 9 in table 1.
(b) NumerEX project—row 8 in table 1.

In both projects rotating liquid metal liners are mechanically pushed to compress a magnetically confined plasma. Both methods share the same drawbacks: (1) The mechanical compression is applied only at the last phase of creation and compression of the plasma so the capabilities and advantages of mechanical energy are not fully exploited; (2) The pressure on the liquid liner must be raised from a low to high value within a short time. This kind of action poses very high demands on the mechanical driving system; (3) Since the compression of the liquid starts from a low-pressure value while the plasma is already dense and compressed by the magnetic fields, the inertial effect of the liquid is precluded. To clarify this disadvantage, compare this process to the bubble compression dynamics: in bubble compression, the liquid is accelerated inwardly against a lower-pressure gas, thereby gaining kinetic energy—inward momentum, which in the later compression phase provides very high inward pressure. On the contrary, the metal liquid liner is pushed inwardly against an already compressed plasma which strongly resists the liquid flow and reduces its inward acceleration.

It is an object of the present invention to provide a method and apparatus for the compression of fusionable materials using mechanical energy stored in a liquid under high pressure, possibly in combination with other compression energies, to create hot and dense plasma.

### Glossary

Shot: Single operation of pulsed energy sources into fusionable material. The time length of the shot is from the start of the energy operation until the plasma decays to a non-useful state.

Quasi static pressure in liquid: The pressure is approximately constant during the relevant time of the process. The relevant time in this invention context is the time of one shot.

“Approximately constant” means that pressure variations during the shot are not detrimental to the process. The use of “pressure” alone will mean “quasi-static pressure” unless otherwise stated or evident from the related context.

Fluid, Gas, Liquid: According to the standard definitions, both liquid and gas are fluids. However, under high temperature and pressure, which may be included in the scope of the invention, the matter may be above its critical point, where no phase difference exists between gas and liquid phases. Similarly, the fusionable gas can be compressed so that its gas-liquid phase is not defined. For clarity and consistency, the term “liquid” will be used for the host fluid, while the fusionable material will be called “gas”, or “material” and it is to be understood that during the process distinction between gas and liquid may be physically impossible.

Host liquid: A liquid, which is driven to high pressure, at least partially enclosing a volume containing fusionable material, which when allowed to flow, provides compressive pressure to the fusionable material. The use of term “liquid” means hear “host liquid” unless otherwise stated or evident from the context.

Solid: In the context of this invention, “solid” will be used to describe material which does not flow under the pressures relevant to this invention during the time relevant to the processes described in this invention. This solid may be compressed or bend under the pressure but does not follow fluid equation of motion. Also, materials like glass at room temperature are sometimes considered as liquid since during long times (years) they flow under pressure. Such material will also be defined as solids in this invention if the typical flow time under the relevant pressure is much larger than the typical time cycle of operation of one shot.

Penetrable barrier conditions: The invention discloses a barrier which does not allow liquid flow through it. Transforming or changing it to “penetrable” conditions means that it enables the flow of liquid through it. The definition includes conditions where part of the barrier becomes fluid and flows with the host liquid. The process of making the barrier “penetrable” will also be called “opening” for liquid flow, and the inverse process is “closing” or “blocking”.

Fusionable material: Materials in any phase containing at least one kind of material whose nuclei can be fused via nuclear reaction to heavier ones accompanied by liberation of energy. Including but not limited to:
Hydrogen (¹H)
Deuterium (²D)
Tritium (³T)
Helium isotope ³He
Mixtures of the above

Fusion Reactor: Apparatus for generation of nuclear fusion reactions in fusionable material.

Reservoir: Tank, container, or any other form of vessel capable of containing liquid intended to be pumped into a high-pressure tank and/or accept liquid pumped out of said tank.

### SUMMARY OF THE INVENTION

The invention discloses method and apparatus for compression of fusionable materials using mechanical energy stored in a liquid under high pressure, possibly in combination with other compression and/or heating energies to create a hot and dense plasma which generates nuclear fusion reactions between light nuclei such as Hydrogen and Helium isotopes. These fusion reactions provide energy that can be used to provide a supply of “green” energy for mankind.

The apparatus is called “fusion reactor”. This apparatus is configured to generate hot and dense plasma particularly useful for energy generation by fusion reactions.

The fusion reactor includes, but is not limited to:
a high-pressure tank defining the external boundary of at least part of a first volume;
a solid barrier defining at least part of the boundary between the first volume and a second volume;
liquid in a reservoir;
at least one pump configured to deliver said liquid from said reservoir into the first volume and to compress it to a high pressure in the first volume;
fusionable material filling at least part of the second volume;
means configured to make said solid barrier penetrable to liquid, allowing liquid flow from the first volume into the second volume.

The solid barrier between the first volume and the second volume can have spherical symmetry or cylindrical symmetry.

The means configured to make the solid barrier penetrable can include at least one energy source configured to liquefy at least part of the barrier.

This energy source can be a pulsed power generator configured to drive electrical current through conductors embedded in and/or adjacent to said barrier. According to an aspect of the invention, the means for making the barrier penetrable to liquid can include ignition of a chemical reaction.

The solid barrier can be composed of a solid supporting structure, said supporting structure has plurality of holes (openings), said holes are covered by a layer of solid material. The layer of solid material can be covered by a film of material capable of exothermic reaction with the liquid.

According to an aspect of the invention, the solid barrier comprises a fixed solid part having at least one hole connecting the first volume to the second volume; at least one shutter configured to block said hole to liquid flow; at least one actuator configured to move the shutter to allow or block liquid flow.

The shutter can include a rod extending out of the high-pressure tank. The shutter has fluid sealing area which can be selected to be matched to the exit area of the rod out of the high-pressure tank, such as to control the force acting on the shutter.

According to an aspect of the invention a plurality of holes and their respective shutters are arranged in a cylindrical symmetry, said shutters are connected to a plurality of actuators, said actuators are configured to operate simultaneously. The fusion reactor can further include an electrical pulsed power generator configured to drive current though the fusionable material and/or through the barrier to provide additional heat and compression to the fusionable material. According to the invention, there are several ways to handle the insertion of the fusionable material into the second volume of the reactor, including but not limited to, inserting the fusionable material encapsulated in a solid container having a volume smaller than the second volume. Said container can be a cylindrical tube made of electrically conductive material. This tube can be prepared for the compression by the host liquid by transforming it to a liquid. The fusion reactor can further include a pulsed power generator configured to drive current through the said tube of sufficient intensity for transforming it to a liquid phase.

The pressure of the liquid in the first volume must be high to provide sufficient compression of the fusionable material. Example calculation included in the description below indicate that this pressure is preferred to be above 10 MPa (100 Bar), or above 100 MPa (1 kBar), depending on barrier configuration.

Therefore it is preferred to include a pump configured to drive the liquid to pressure above 10 MPa or above 100 MPA.

The time during which the barrier is transformed to penetrable to allow liquid flow from the first volume into the second volume must be short to provide efficient and uniform compression of the fusionable material. Depending on the specific configuration, it is preferred that the means for making the barrier penetrable are configured to do it within 10 milliseconds or within 1 (one) millisecond or within 100 microseconds.

The invention discloses a method for generation of dense and hot plasma particularly useful for generation of fusion reactions.

The method includes, but is not limited to:
inserting a solid barrier into a high-pressure tank, constituting a boundary between a first volume and a second volume;
pumping liquid into the first volume and driving it to a high pressure;
inserting fusionable material into the second volume;
applying means for making said solid barrier penetrable to liquid to allow liquid flow from the first volume into the second volume.
   The method can further include ignition of chemical reaction for making the barrier penetrable to liquid.

According to an aspect of the invention, the method can include moving simultaneously a plurality of shutters to allow liquid flow from the first volume into the second volume.

The method can further include driving current through the fusionable material and/or through the barrier to provide additional heating and compression force.

According to the invention, there are several possible ways of inserting the fusionable material into the second volume. The time of this insertion can be before pumping the liquid into the first volume, or before or after driving it to a high pressure, but it preferably precedes the time of transforming the barrier to be penetrable.

The fusionable material can be inserted into the second volume as gas. Following the insertion of the fusionable material into the second volume energy can delivered to make said material a plasma.

Another way according to the invention is to drive the fusionable material to a plasma state before inserting it into the second volume.

According to the invention, electrical current can be driven through the plasma formed in the second volume after the barrier is opened for liquid flow to provide additional heating and/or compression.

According to an aspect of the invention, a liner encapsulating fusionable material is inserted into the second volume. Electrical current can be driven through the liner to melt it and/or electrical current can be driven through the liner to compress it by the magnetic field generated by this current.

### BRIEF DESCRIPTION OF THE DRAWINGS

Non-limiting examples of the present disclosure are described in the following description, read with reference to the figures attached hereto, and do not limit the scope of the claims. In the figures, identical and similar structures, elements, or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 schematically describes a spherical barrier between a first, high-pressure volume, containing liquid, and a second, low-pressure volume, containing a fusionable material and means for transforming said barrier to fluid.

FIG. 2 illustrates an example of a cylindrical barrier between a first and a second volume, including an example for energy source used for making the barrier penetrable to liquid. This energy source is pulsed power generator for driving high current through the said barrier.

FIG. 3 illustrates an example of a solid supporting structure, supporting an enclosed solid barrier.

FIG. 4 illustrates an example of igniting a chemical reaction which transforms at least part of the solid barrier to a fluid to enable host liquid flow from the first volume to the second volume.

FIG. 5 illustrates an example of shutter/valve which can close or open passages (holes) in a solid barrier to enable and/or stop the liquid flow from the first volume into the second volume.

FIG. 6 shows a few examples of sealing the shutter to the barrier. (a) Conical sealing. (b) Face sealing. (c) Cylindrical sealing.

FIG. 7 illustrates various options for inserting fusionable material into the second volume, including the option of plasma production and heating in the fusionable material before and/or after the insertion of the material into the second volume.

FIG. 8 shows an example of fusionable enclosure in a volume smaller than the second volume. This example depicts a cylindrical tube enclosing the fusionable material which is inserted coaxially with the solid barrier. Optional electrical pulse generator is included which can transform said tube to a liquid.

FIG. 9 illustrates an example of the integration of the disclosed invention in a reactor for energy generation. In addition to the basic elements of the invention, auxiliary systems are included.

### DESCRIPTION OF THE INVENTION

Liquid compressibility acts like a “spring” which can store energy under pressure. The energy density which can be stored in a liquid under high pressure is comparable, and even higher than that of electrical capacitors. For example, take pure water. The compressibility is about k=0.3×10⁻⁹ Pa at a pressure of 100 Mpa (1 kBar), which reduces to about k=0.2×10⁻⁹ Pa at 1 GPa (10 kBar). Assume a volume V of water pressed to 1 GP and then allowed to expand until the pressure drops by 10%—by 100 MPa. The volume change is approximated by ΔV=kVΔP=0.2×10⁻⁹×V×10⁸=0.02V (2% change). The approximate work done is W=ΔV*P=0.02V×10⁹=2×10⁷V. Assume a modest container of 100Litter=0.1 m³, one gets W=2×10⁶J=2 MJ. It must be emphasized that commercial equipment for ultra-high pressure exists up to pressure of about 1 GPa (10 kBar). For example, SITEC—Sieber Engineering AG, Aschbach 7 CH-8124 Maur/Zurich, Switzerland.

From bubble physics and prior art review one can appreciate the compressing power of fluid inertial forces. In the prior art a volume of low-pressure gas (a bubble) is first produced in a host liquid. Then the pressure of the liquid is rapidly raised either locally by focusing ultrasound or shock waves or more slowly by hydraulic means pressurizing the whole liquid. The enforced pressure difference at the liquid-gas boundary accelerates inwardly the liquid, which gains kinetic energy—momentum directed inwardly. This kinetic energy is concentrated by the spherical geometry and, when decelerated by the compressed bubble gas, generates very large pressure at the bubble center. The disadvantages of prior art where the rising pressure is achieved by either by a pressure wave or by pressurizing all the liquid in a container were pointed out above. It is better to start with a host liquid at high static or quasi-static pressure, then release it toward the low-pressure volume. This way, the initial acceleration is the largest, driving the liquid to very high kinetic energy before the opposing pressure of the bubble gas grows to a significant value.

It is an object of the present invention to disclose a method and apparatus for compressing fusionable material by controlled release of liquid under pressure into a volume initially at lower pressure than the liquid pressure. A first volume is initially containing liquid under high pressure will be also named “high pressure volume”. A second volume is initially at pressure lower than that of the host liquid in the first volume and named “low pressure volume”. The first and the second volumes are separated in at least part of their periphery by a solid barrier. Said barrier prevents flow of liquid from the first volume into the second volume. At least part of the low-pressure volume contains fusionable material. The solid barrier can be “opened” or become “penetrable” in the sense that it allows liquid flow from the first volume into the second volume, thereby compressing the fusionable material. The terms “open” and/or “penetrable” will be used to describe the condition where at least part of the solid barrier allows liquid flow from the first volume into the second volume including possible phase transition of at least part of the barrier from solid to liquid or gas which can flow. The term “fluid” will be also used in this context.

Without limiting the scope of the invention, examples of host liquids are: water, heavy water—D₂O, Acetone, Deuterium Acetone, Oil, Glycerin, molten metals or metal alloys such as Lead (Pb), Lithium (Li), Gallium (Ga), Lead-Lithium alloy. The liquid may be heated to a higher than room temperature for various reasons, for example, keeping it in liquid phase, and/or preheating of barrier material.

The range of parameters includes but is not limited to:

The pressure in the first volume is preferably as high as possible since the mechanical potential energy (PV) is higher. On the other hand, very high pressure comes with technological challenges. The initial pressure in the second volume must be lower than the pressure in the first volume to enable inward acceleration of the liquid to gain momentum and kinetic energy. Without limiting the scope of the invention, the above considerations and additional examples given below teach us that for the high densities required for fusion, pressure above 100 MPa (1 kBar) is preferred. Pressure above 1 GPa (10 kBar) is also preferred but requires development of custom designed equipment.

Range of parameters according to the invention includes but is not limited to:
Liquid pressure above 10 MPa (100 Bar)
Liquid pressure above 100 MPa (1 kBar)
Liquid pressure above 1 GPa (10 kBar)
Initial pressure in the second volume is at least 10 times smaller than the liquid pressure in the first volume.
Initial pressure in the second volume is at least 100 times smaller than the liquid pressure in the first volume.
Initial pressure in the second volume is at least 1000 times smaller than the liquid pressure in the first volume.

Large pressure difference between the first and the second volume is preferred since it increases the inward liquid acceleration after opening of the barrier.

The time it takes to transform the barrier to be penetrable is also important. Shorter time is preferred to improve compression symmetry. The required time is dependent on the liquid type, liquid pressure, barrier thickness and barrier radius. As an example of rough estimate, assume that during the opening time of the barrier the liquid can gain velocity of 10 m/sec. Assume cylindrical barrier of radius R=10 cm, and demand that during the opening time the liquid will not move more than 10% of this radius, namely, 1 cm. For this example, the time for barrier opening is better be less than 1 millisecond. Considering various configurations, the ranges for barrier opening time can be selected as:
within 10 milliseconds; or
within 1 millisecond;
within 100 microseconds.

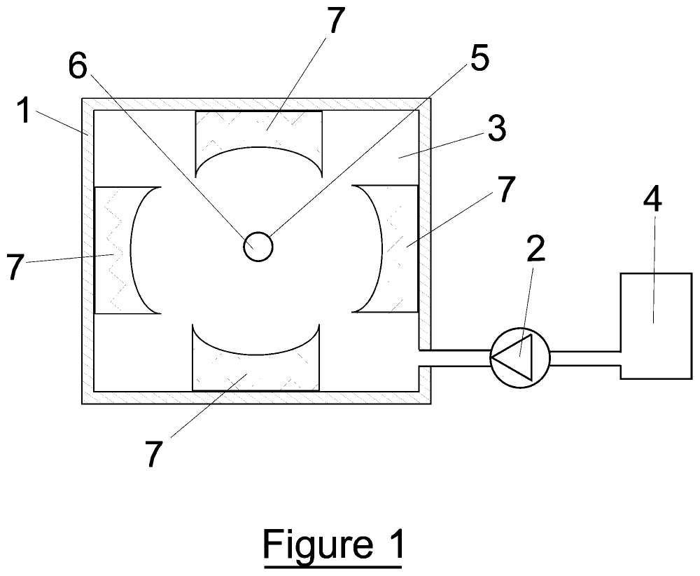

Refer to FIG. 1. A high-pressure tank 1 defines the external boundary of at least part of a first volume 3, which will also be called “high-pressure volume”. The high-pressure tank 1 is connected to at least one high-pressure driver—a pump 2, capable of delivering liquid from a reservoir of liquid 4 into the first volume 3 and raising the pressure of said liquid in the first volume to very high quasi-static pressure. A solid barrier 5 defines the external boundary of a second volume, also called “the low-pressure volume”, and constitutes a container, which is at least partially filled with fusionable material fluid (gas or liquid) 6 at a pressure significantly lower than the pressure of the liquid in the first volume 3. This solid container is inserted into the host liquid in the first volume, either before or after driving the liquid to the high quasi static pressure. When inserted into the high pressure tank 1, this container 5 constitute a barrier between the first volume 3 and the second volume 6. This container can be stabilized, if required, by strings or by ultrasound pressure from transducers located at various positions in the tank (not shown). When the solid container is inside the liquid and the pressure of the liquid is high the solid barrier is transformed to a condition that allows liquid flow from the first to the second volume, this transformation is called “opening” of the barrier and/or making it “penetrable”. In the example shown in FIG. 1, energy is applied on the container walls, transferring it from solid to fluid—either liquid or gas, said fluid pushed inwardly by the host liquid from the first volume. Eventually, inward flow will start, compressing the fusionable material inside the second volume to produce hot and dense plasma.

Means for transforming the solid barrier from solid to fluid are depicted in FIG. 1 as numeral 7, include, but not limited to:
(a) Beams of laser.
(b) RF/Microwaves.
(c) Ultrasound waves.
(d) Magnetic induction—non-contact heating via eddy currents induced by external coils.
(e) Current drive—suitable for cylindrical container, but also possible through wires connecting a spherical shell.
(f) Chemical reaction. Can be ignited by one of the above, or by electrical ignition. Such reaction can cause the solid to become fluidic even without passing the solid-liquid phase transition.

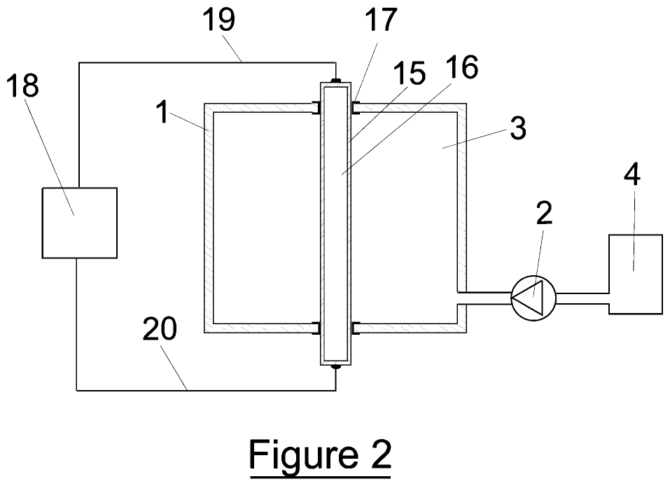

The container (barrier) 5 in FIG. 1 is spherical. A spherical container will behave after the barrier opening like a bubble under pressure, with volume compression ratio of (R0/Rm)³. A cylindrical container (barrier) will provide a lower volume compression ratio, (R0/Rm)², but has certain advantages to be discussed later. It is depicted in FIG. 2.

The advantages of using mechanical energy for compression were disclosed above. The advantages of this invention over prior art using mechanical energy are:
(a) The mechanical compression starts at the highest pressure, most efficient for inward liquid acceleration and gain of momentum and kinetic energy which later on is transformed to extremely high pressure on the fusionable material in the second volume.
(b) Oscillatory compression-inflation is possible, which enhances the [nτ] product which is important for exceeding the Lawson criterion. Such oscillatory motion can be enhanced by energy from fusion reactions.
(c) The pressure of the liquid is quasi-static during the flow phase, improving the stability and symmetry of the compression of the fusionable material.
(d) Quasi-static pressure is easier and cheaper to produce and produced much more efficiently than pulsed pressure or pressure wave or ultrasound waves, or shock waves.
(e) Compared to prior art bubble-based fusion, the solid container/barrier is excellent for optimal selection of fusionable material composition and pressure, with no link to the host liquid.
(f) Relaxes the limiting dependence between selection of host liquid material and optimal bubble dynamics. The host liquid need not be of low vapor pressure or be degassed since it has no direct contact with the fusionable material. The container walls can be made of materials with the best properties, for example, low vapor pressure, low compressibility, high density (for good inertial push at the final compression), and high atomic mass number Z.

Advantages (a)-(d) stated above are specifically relevant to differentiate the invention from prior art similar to that disclosed by General Fusion Inc. and NumerEX projects. There the liquid liner is pushed from a low to high pressure while the plasma is already inside the liner and is at high pressure, so fast inward acceleration and gain of momentum and kinetic energy by the liquid is not effective. The “spring” like PV potential energy of a host liquid under high quasi-static pressure is not exploited in these prior art projects. The energy is delivered to the liquid liner by external means and do not come from its internal pressure.

There are few ways to optimize the solid-fluid transformation. The host liquid temperature can be selected to be close but below the wall material transformation temperature. The wall can be made from a metal shell. The thinner possible wall depends on the liquid pressure. Higher degree of spherical or cylindrical symmetry allows the use of thinner wall. Selection of material of high strength and low melting temperature is preferred. For example, Beryllium-Copper (BeCu) or Aluminium 7075 alloy. Multilayer wall can be optimized for strength, energy absorption, fusionable material coexistence, and flow properties.

Examples of possible embodiments and relevant parameters are given below. Obviously, the invention is not limited to these examples.

### Example 1—Spherical Shell Barrier

Assume a solid barrier made of BeCu alloy, spherical shape of radius R=10 mm and thickness of t=1 mm. Two theoretical formulas for the buckling pressure of a sphere are known. First, the elastic dependent one:

$${P}_{cr} = \frac{2 E}{\sqrt[2]{3 ( 1 - {v}^{2} )}} \cdot {( \frac{t}{R} )}^{2}$$

Where E is the elasticity and v is Poisson ration. Pcr and Py are the maximum possible liquid pressures according to the respective formula.

For BeCu data and t/R of 10 we obtain E=2 GPa. The second formula is tensile strength limited:

$${P}_{y} = 2 \cdot Y \cdot ( \frac{t}{R} )$$

Where Y is the tensile yield strength of the material, which is 1.2 GPa for BeCu alloy.

This equation gives 240 MPa for t/R=10, lower than the elasticity based equation. Experimental tests give lower failure pressures, depending on how close the spherical shell is to perfect spherical symmetry and to perfect uniform shell thickness. Taking Pmax=200 Mpa (2 kBar) as the maximum pressure on a well built shell, the performance can be estimated. Assuming the gas pressure inside the spherical container is negligible compared to the host liquid pressure, the hydrostatic energy can be calculated as

$$PmaxV = P m ax ( 4 / 3 ) π {R}^{3} = 200 \times {10}^{6} \times ( 4 / 3 ) \times π \times {( {10}^{- 2} )}^{3} = 837 J .$$

Next, assume an ideal no-loss situation, where all available mechanical energy is going to the compressed fusionable gas. For the initial density of 10¹⁷/cm³ D2 molecules, the number of D atoms in the sphere is 2×4.2×10¹⁷, and the average energy for each D atom is 10-15J=0.6×10⁴ eV=6 keV. This is not optimal for D-D fusion but can be sufficient for D-T fusion process. Assume radius compression ratio of Rmax/Rmin=10, then volume compression factor is 1000, giving maximum fusion gas density of 10²⁰/cm³=10²⁶/m³. For D-T reaction the Lawson criterion will be satisfied for compression time longer than 10 μsec. For volume compression of 100,000, the required time reduces to 100 nsec. If the implosion is nearly at ideal spherical symmetry and no explosion occurs at maximum contraction, then multiple oscillation of this artificial bubble may be obtained. Generation of fusion energy in this bubble further enhances the amplitude of the contraction-expansion cycles and provide more energy.

The volume of the spherical shell of the above example is 1.4 cm³. About 1 kJ is required to raise the temperature of the BeCu shell by 200·C, which is an estimate for effecting solid to liquid transition, assuming the host liquid is kept at temperature less than 200·C below BeCu melting temperature at the liquid pressure. In addition, to complete the phase transition to liquid, additional 2.7 kJ is required for the latent heat of fusion. The total energy delivered is 3.7 kJ, much greater than the gained PV energy of 837 J. In the following better configurations according to the invention are disclosed, which provides better ratio between the mechanical energy PV to the energy required for melting the barrier.

FIG. 2 depicts a cylindrical barrier configuration. The high-pressure tank 1 and the cylindrical tube 15 defines the first volume 3. The cylindrical tube 15 is the solid barrier and defines the second volume 16, which is inside the tube. The term “liner” can also be used in to describe the tube 15. It is convenient to have at least one end of the tube extending it out of the high-pressure tank 1. The cylinder supported and sealed at the high-pressure tank exit holes by seals 17. These seals are drawn in a schematic way and can be designed in any form. It is preferred to make these seals from electrically insulating material, so high voltage pulse can be applied between the tube ends via conductors 19 and 20 from pulse generator 18. This configuration enables easy replacement of barrier 15 after each shot. Cylindrical barrier geometry is less efficient in compression than spherical one, since the volume compression ratio is proportional to (Rmax/Rmin)² instead of the cubic dependence of spherical container.

Also, the maximum withstanding pressure of a cylinder is lower than that of a sphere with the same t/R ratio. On the other hand, a cylindrical tube barrier has the following advantages:
Energy for making the barrier penetrable can be delivered by driving a current pulse through it, by an electrical pulse driver 18 through conductors 19 and 20.
A pulsed current through the tube generates magnetic compression on the liner in addition to the mechanical exerted by the host liquid. It can be applied at any stage of the compression process: before, during and/or after the compression done by the host liquid.
Easy insertion, positioning and extraction into and from the high-pressure tank 1 compared to a sphere.
Fusionable material can be inserted easily through at least one of the tube ends.
Possibility of exciting initial plasma in the tube before the action of the mechanical compression and/or injection of plasma created elsewhere into this second volume, through at least one tube ends extending out of the high-pressure tank 1.
Possible delivery of additional energy to the plasma formed in the second volume through at least one of the tube ends extending out of the high-pressure tank.
The total active volume can be large since the tube can be long.

### Example 2—Simple Cylindrical Barrier

Based on a literature survey, for R=10 mm, t=1 mm BeCu tube maximum withstanding pressure is about 50 MPa (500 Bar). Using support rings (internal or external) and strictly keeping symmetry and uniformity can raise the pressure holding to 100 MP (1 kBar). Following calculations similar to those done for a sphere, for 1 cm length of active tube. The volume per 1 cm length is 3.14 cm³. The PV energy is 314 J per cm length. Starting with 10¹⁶/cm³ density, 30 keV is the maximal average energy per atom. This is good even for D-D reactions. Assuming volume compression of 1000, density of 10¹⁹/cm³=10²⁵/m³, so 100 μsec compression time is required for D-T reactions. Note that the selection of initial density (before compression) affects both the energy available per atom and the maximum density. Lower initial density enables higher energy per atom, but the ultimate density is lower. The mechanical stress on the tube continues along the shot time since the pressure of the host liquid is quasi-static. Therefore inward-outward oscillations are possible, enhancing the fusion processes. Additional energy and pressure can be provided by driving current through the metal liner (tube) 15 and/or through the plasma. The azimuthal magnetic pressure created by this current can provide additional contraction and confinement of the plasma.

The energy required to raise 1 cm length of the BeCu tube is now calculated. The volume is 0.6 cm³/cm, multiplying by 2.2 J/cm³/K gives 264 J per cm length for 200 degrees C. temperature raise. Additional 1.15 kJ is required for the latent heat of fusion. This is high compared to the 314 J gained by the mechanical energy. Better configurations will be disclosed below, providing much better ratio of PV energy to melting energy.

The following examples will be on cylindrical symmetry of the barrier, however, the invention is not limited to this symmetry.

### Scaling in Cylindrical Geometry

It is advantageous to increase barrier tube radius R since:
Compressed volume is proportional to R², surface interaction area between the first and second volume grows by R, so the ratio of volume plasma energy to surface energy loss proportional to R, so that increasing R reduces losses fraction.
For disposable container it is better to have more fusionable mass in each shot, with larger R the second volume is larger, accordingly the potential energy PV is larger, enabling more fusionable material in each shot.
The cycle of volume contraction and expansion is slower, giving more time to the compression phase which is important for exceeding the Lawson criterion.

However, as discussed above, the critical strength of a simple cylindrical tube is dependent on (t/R), so for increasing R and keeping host liquid pressure, tube thickness t must be increased as R increased. For constant pressure P the energy per cm length is proportional to R². The volume of the barrier tube wall is proportional to Rt, and since t−R, it is also ˜R²

The end result is that the ratio of PV energy to the energy required to melt the barrier tube wall is constant, and cannot be decreased by increasing tube radius R.

### Barrier Supporting Structure

According to an aspect of the invention, to enable both high pressures withstanding of the barrier and low energy required for making it to penetrable, a supporting structure is disclosed. This supporting structure holds (supports) the barrier material between the first and second volumes. The supporting structure provides strength against the high pressure of the first volume and relaxes the dependence of the required barrier thickness on tube radius. The supporting structure may be a solid grid designed for maximum strength with openings (holes) providing passageways for the liquid flow from the first volume into the second volume. This configuration enables increasing tube radius R without increasing barrier thickness t, and for constant R, smaller t may be used for the same pressure and material. The price paid is increased energy loss during the flow of the liquid through the holes in the supporting structure. Liquid viscosity must be taken into consideration when selecting hole size and structure, together with the strength considerations. It is helpful that the flow velocity is the smallest at the external side of the supporting structure and since viscos loss is proportional to velocity, the energy loss is expected to be tolerable (liquid velocity increases rapidly towards the center, lowest at the outermost radius).

### Example 3

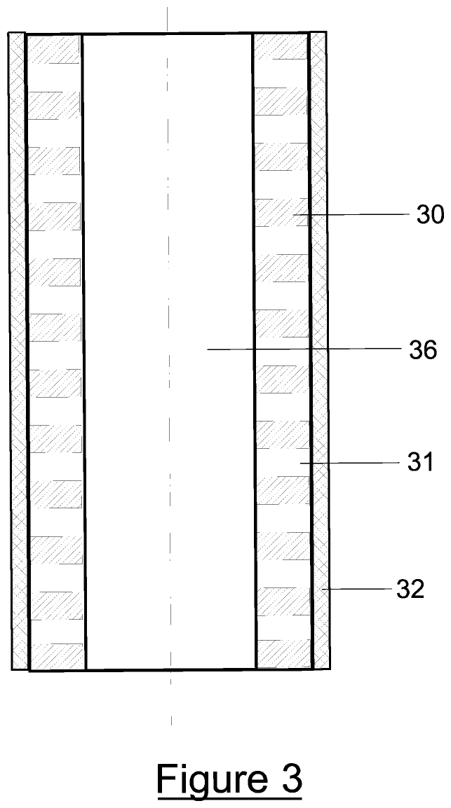

An example of embodiment according to the invention is illustrated in FIG. 3. The supporting structure in this example is a tube 30 made of high strength material such as steel. The tube includes a dense array of wall-penetrating holes 31. The holes may be circular or of any other geometry. For example, the supporting tube can have external radius of 60 mm, internal radius of 50 mm, and an array of holes of diameter 2 mm. The supporting tube is enclosed by a solid tube without holes 32, which closes the passage of liquid from the first volume into the second volume. The fusionable material is inserted into the second volume 36. For example, said solid tube 32 can be made of a high-strength plastic material, such as Torlon PAI 4203. This material tensile strength is about 150 MPa, so it is estimated that thickness of t=2 mm will hold about 300 MPa (3 kBar) of external host liquid on 2 mm diameter holes in the supporting structure 30. The PV energy in the second volume 36 is about 30 kJ per cm length of the tube. The Torlon PAI 4203 plastic has a glass transition at 286 degrees C., following by orders of magnitude decrease in strength when the temperature is increased further by 20 degrees C. (this is the process of turning the solid plastic tube to a liquid). Therefore, a change of about 50 degrees C. may be sufficient for releasing the inward flow. The volume per cm length is 7.5 cm³, heat capacity is 2.3 J/cm³ (for temperatures close to glass transition), so for 50 degrees C. change 860 J is required per cm length, only about 3% of the energy gained from the pressure of liquid. A step of 100 degrees C. requires 1.7 kJ per cm length, about 6% of the PV energy per cm length. This example shows the advantages of using supporting structure: larger diameter R, higher pressure, greater PV potential energy per unit length, and higher ratio of PV energy to the energy required to release it to action.

Heating of this 2 mm plastic tube must be fast and optimized with respect to heat conduction to the host liquid and supporting structure. As an example, heating of the plastic tube can be done by driving electrical current through conducting films external and/or internal of the plastic tube 32 and/or thin wires embedded in the plastic tube 32 (not shown in FIG. 3). The geometrical distribution of these conductors and the distribution of the currents in them can be preferably selected to optimize the solid to liquid transition. Another heating option is to make the plastic tube 32 at least partially conductive and drive electrical current through it.

To illustrate the total energies involved in one shot, take as example length of the active tube length of 50 cm. The total PV potential energy is 1.5 MJ, equivalent to the energy delivered to the pellet in the world largest laser confined fusion facility—NIF. The energy for liquifying the solid plastic tube is about 100 kJ. Energy density of high voltage pulse capacitors is about 1 J/cm³, so about 100 L capacitor volume is required. A 100 kV×100 kA pulse can provide 100 kJ within about a hundred microseconds. Much higher currents are available in the art of pulsed power, so this time can be reduced as required for optimal performance.

According to the invention, any means for transforming to liquid, the solid barrier blocking the host liquid can be applied. The electrical energy can be delivered by induction to conductors located close to or inside the plastic tube 32. Application of ultrasound, microwaves, laser, or other forms of energy is included in the invention. Ignition of an exothermal chemical reaction is also disclosed in this invention. The chemical reaction can provide heat or directly transform the solid barrier material to a fluid—gas/liquid or to a material soluble in the host liquid.

### Example 4

An example of using a chemical reaction is disclosed. This example is based on chemical reaction between a material added externally to the tube 32 and the host liquid. However, according to the invention any chemical reaction can be used. For example, chemical reaction between constituents attached to tube 32 or embedded in this tube with or without involvement of the host liquid.

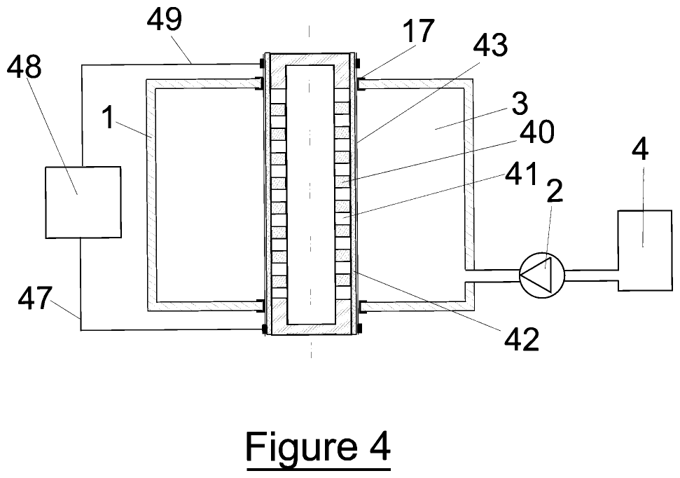

As an example, water-metals reaction can be used. It is well known that alkali metals, such as lithium (Li), sodium (Na), potassium (K), rubidium (Rb), cesium (Cs), interact strongly with water. For some material the reaction can start at room temperature immediately when the water gets in contact with them, while for others higher temperature is required. Other metals can also be considered, such as aluminum (Al). Without limiting the scope of the invention, in this example, Lithium (Li) will be detailed, and the liquid is water. FIG. 4 discloses a cylindrical supporting structure 40, having an array of holes 41, enclosed by a solid tube 42. Said tube is the barrier between the first volume and the second volume. On top of this tube, a thin Lithium (Li) foil 43 is added. The Lithium foil will be covered by a very thin layer, of few microns or less, made of a material which does not interact with water under the pre-shot conditions of the system. A thin layer of Aluminum or plastic materials can be used. It is preferred to use desalinated water which has low electrical conductivity. If barrier tube 42 is made of conducting material, a thin insulating layer can be added below foil 43.

According to the invention, a chemical reaction will be ignited between the metal foil and the host liquid. This ignition must be controlled and fast. According to an aspect of the invention the ignition of said reaction can be done by a current pulse driven through the foil. FIG. 4 shows the cylindrical assembly 40, 42, 43 mounted in high pressure tank 1. Pulse generator 48 drives current pulse via wires 47,49 into the Li foil 43 to initiate a chemical reaction between the Li and the water.

As an example, calculations were done based on the physical data of Lithium and the specific example configuration, as follows. Lithium foil 43 of thickness 25 microns. The radius is R=60 mm. The host liquid 3 is desalinated water. The length of the cylinder is not limited, as an example, consider 50 cm length. It is convenient to calculate for 1 cm length of the cylinder. The current driver is pulse generator 48, capable of driving a current of a few tens up to a few hundred kiloampere (kA) for a typical time between 1 and 100 microseconds, or up to 1000 microseconds. As an example, a sinusoidal shape current with half cycle time of 20 microseconds and a peak current of 400 kA. It is found from calculations that full transition to liquid state occurs after about 6.7 microseconds, after electrical energy of 50 J per cm length was delivered to the Li foil. It may be enough for ignition of Li-water reaction. The Li melting temperature is 180 degrees C., so it is enough for eliminating a very thin plastic layer which prevented this reaction before the pulse. The current pulse can push the Lithium foil to higher temperature, to obtain faster reaction. Two important points are the start of boiling and the complete transition of the foil to gas. The first point is when boiling temperature is obtained. For Li it is 1340 degrees C. Up to this point, the electrical system has to drive about 300 J per cm length. With the 400 kA sinusoidal pulse, it will happen 10.7 microseconds after the pulse start. Li boiling is excellent condition to induce intense chemical reaction between the Lithium and the water.

Additional 1 kJ per cm length of electrical energy will provide the latent heat of vaporization and drive all the foil material completely into the gas phase, creating fast and intense chemical reaction. With the example current drive, it will happen at 17 microseconds.

Obviously, these numbers are only first-order estimation, neglecting the effect of pressure and heat conduction. Also, the magnetic pressure created by the intense current was not included in the calculations. This magnetic pressure can be helpful in pushing the foil inwardly. If the current is sufficiently high, a phenomenon known as foil explosion will occur, which is helpful for getting a fast and intense reaction. From the above example, one can infer that the minimal energy which has to be invested in the foil to induce a reaction is 50 J per cm length. The more intense reaction is expected above 300 J per cm length, and 1.3 kJ per cm length will guarantee a fast and intense chemical reaction. To illustrate the total energies involved, assume the cylinder length is 50 cm, so a total of 65 kJ is required for the most intense chemical reaction ignition. The current pulse which has to drive this energy is well within the known in the art capabilities of pulsed power technology. For example, a pulse forming generator composed of a capacitor connected via a switch and transmission conductors to the foil. Simulation was done for a 40 pF capacitor charged to 70 kV, storing energy of 100 kJ. The series inductance was taken as 1 pH and series resistance (excluding the foil) 10 m?. Initial foil temperature was 100 degrees C. About 14 μS after turning on the switch, all the foil was converted to gas phase.

The energy of the Li-water reaction is 222 kJ/mol. For ⁷Li it is 32 kJ/g. Li density (room temperature) is 0.534 g/cm³, giving 17 kJ/cm³ Li at room temperature. The initial volume of the foil in the above example is 2×3.14×6×25×10⁻⁴=9.42×10⁻² cm³ per cm length. Finally, we get 1.6 kJ per cm length. The 2 mm plastic barrier disclosed in example 1 will be heated by almost 100 degrees C. Additionally, about 1 kJ per cm invested by the electrical energy in the foil will also be contributing to the melting of the plastic layer.

The mechanical energy PV operated by the barrier transforming from solid to liquid in this example is about 30 kJ per cm length, 1.5 MJ for a tube of 50 cm length. The estimated energy for transforming the barrier is less than 10% of the gained PV energy.

The current driven into the metal foil creates a strong theta (azimuthal) magnetic field and, therefore strong inward pressure which is added to the inward host liquid pressure. The energy invested by the electrical system beyond the boiling point is not lost, but rather contributes to the heating and compression of the fusionable material.

Significant percent of the energy taken by the host liquid can be used either for the process itself or transformed to electrical power by standard methods known in the art.

An advantage of the cylindrical geometry is that the radius R and the length can be chosen for the best performance. A longer tube provides more fusion energy per shot so that the average power production can be increased. It is better to have long tube compared to the tube radius R since the end effects are less prominent. For example, the length may be greater than the tube radius R, greater than 10R, or greater than 100R. In the above example, 50 cm length was selected for a 6 cm radius.

According to the invention, any value of tube radius R can be chosen. Power stations are large facilities, so the size of the host liquid tank is not a major issue. According to the invention, there are few advantages for larger R. Since disposable materials may be involved, it is preferred to obtain more energy per shot. The energy per shot is proportional to R². The PV energy is proportional to R², while the energy for releasing the barrier of the pressurized host liquid is proportional to R. For example, increase the radius of the barrier tube of the above example by a factor of 5, so R=30 cm. The PV energy (at pressure of 300 MPa) will be 750 kJ per cm length. Take length of 10R=300 cm, then the total PV energy is 225 MJ. The energy required for vaporizing the Li foil will grow 5 times, to about 0.5 MJ, now, it is only 0.2% of the PV energy. One can assume that due to instabilities, the minimal radius at maximum compression will also grow with R, but it is reasonable to expect similar compression ratio. Taking this assumption, it is advantageous to increase R since during maximum compression, the radius of the plasma is also larger. A larger radius of the compressed plasma means more fusionable material with reduced losses at the plasma boundaries since the surface area is proportional R while the volume is proportional to R2.

While specific numbers were given in the examples above, it is only a demonstration and does not limit the scope of the invention. Obviously, these are first-order estimates and do not represent optimized set of parameters.

### Mechanical Shutters/Valves

An object of the invention is to provide compression of fusionable materials to high densities and temperatures by controlling the flow of pressurized liquid from a first volume, which is a high pressure volume, into a second volume having lower internal pressure. According to the invention a barrier between the first and the second volume is closed when the pressure in the first volume is raised, preventing liquid flow into the second volume.

When the pressure in the first volume is at the designated high value, the barrier is changed in a way that enable the flow of the liquid into the second volume. One way to effect this barrier change, which was disclosed above, is based on transforming a solid barrier to fluid. The drawback of this way is that the barrier material is disposable and must be replaced between shots. It is advantageous for an energy providing reactor to enable multiple shots without the need to replace the barrier.

According to another aspect of the invention, a mechanically operated barrier is disclosed, capable of multiple “open” and “close” operations. The barrier comprises a solid fixed part having openings (holes) connecting the first volume to the second volume, and “shutters” which can block (close) this openings to liquid flow. The release of the liquid flow from the first volume into the second volume can be done by fast mechanical movement of said shutters. The name “shutter” is used since it is related to physically shutting the way for the liquid flow. The barrier can include a plurality of shutters. Fusionable material fills at least part of the second volume. A compression shot is operated by moving at least one shutter from a first position where it blocks (close) the passage of the liquid to a second position allowing the liquid to flow into the second volume. This process will also be named making the barrier “penetrable” to the liquid and/or “opening” the barrier for liquid flow.

According to the invention transformation of the barrier from a closed to an open state must be fast. It is best to move the shutter as fast as possible, so the flow of the host liquid has a sharp start. It is important for the formation of symmetrical inward flow. Slow shutter opening might create nonuniformity of the flow across the released liquid boundary. An estimation for the required speed of the opening operation was disclosed above. It is preferred that the opening action will be shorter than 10 milliseconds, or shorter than 1 millisecond, or shorter than 100 microseconds. The shutter movement from the first position to the second position must be completed within 10 milliseconds, or within 1 millisecond, or within 0.1 milliseconds. The exact requirement depends on the dimensions of the barrier, on the liquid material and on the liquid pressure.

On the other hand, the inverse operation of closing the passage holes by pushing back the shutters to the first position, can be done slowly. Shutters structures and spatial distribution keeping cylindrical symmetry are preferred to promote symmetrical compression. A plurality of shutters arranged in a cylindrical symmetrical way must be operated simultaneously. Some asymmetries in shutter distribution can be corrected by shutter operation timing. Optionally, it may be advantageous to apply shutter opening timing varying along the length of the tube, yet keeping the cylindrical symmetry, to create advanced compression near the tube ends, so a pressure is formed at the ends of the tube to confine the plasma formed in this tube.

The advantages of using shutters compared to transforming solid barrier material to liquid are: (1) repeated use—no disposables. (2) Optional closing of the barrier at optimal timing for the process, optionally without the need to lower the pressure for preparing the next shot. (3) Host liquid working pressure can be higher since there is no link between barrier strength and energy required for opening the barrier.

Any configuration of shutter is included in the scope of this invention. The example below is for illustration of the invention and not limiting it.

### Example 5

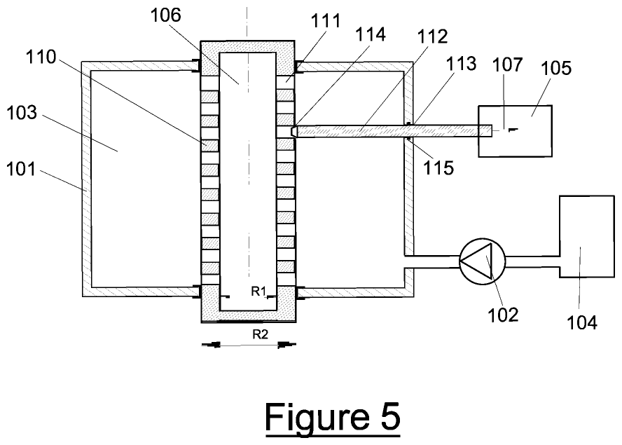

The embodiment is sketched in FIG. 5, showing a high-pressure tank 101, a high-pressure pump 102, the first volume 103, and a reservoir for liquid 104. The barrier between the first volume 103 to the second volume 106 includes a tube 110 inserted in the high-pressure tank 1. The tube has internal radius R₁ and an external radius R₂. Tube thickness R₂−R₁ is selected to withstand the pressure difference between the first and second volumes. This pressure difference can be greater than 0 MPa (100 Bar) or greater than 100 MPa (1 kBar) and even greater than 1 GPa (10 kBar). A plurality of holes 111 in tube 110 connects the first volume 103 to the second volume 106. Said holes can conveniently be circular. The hole bore diameter D is selected big enough to allow low loss flow when open but not too large compared to the radius R₁ since azimuthal symmetry is preferred during the compression phase when the liquid allowed to flow towards the center of the tube. It is better to select 2πR₁/D>=3, or 2πR₁/D>=6, or 2πR₁/D>=12. It is better to distribute these holes in a symmetrical way with respect to the axis of tube 110 to support symmetrical compression of the fusionable material in the second volume 106.

Opening and closing the passage holes 111, allowing and blocking flow of liquid from first to the second volume, is done by shutters.

Note that standard valves technology known in the art is not applicable here since: (1) The pressure is very high; (2) the opening time must be very short. Typical pressures and times were disclosed above. To illustrate the difficulty, assume a washer required to cover and close a 1 cm² hole. The force acting on it by a 1 GPa host liquid is 10⁵ Newton, equivalent to a weight of 10 metric Tons (10,000 kG). This force must be exerted to open the hole for liquid flow. Added to this enormous force is the requirement to move the washer within 1 millisecond.

According to an aspect of the invention, the shutter embodiment includes balancing the forces exerted on the shutter by the high-pressure liquid. An example for such balancing of the force on the shutter is by including a rod 112 (FIG. 5) extending out of the high-pressure volume through exit 113. The cross-sectional area of the rod at the exit hole is matched to the area of sealing side 114, so that the net force on the rod is very low. Let the sealing contour 114 of the shutter enclose an area As. The exit 113 of rod 112 from the high-pressure volume is through a cross-sectional area Ae. As an example of said matching, selecting As=Ae balances the liquid pressure force on the rod, so the total force is close to zero. Selecting As slightly larger than Ae creates inward force on the rod, which can help sealing. The area difference As−Ae and the pressure set the net hydrostatic force on the shutter. Actuator 105 pulls the rod strongly in the outside direction 107 to open the barrier for the passage of liquid from the first volume into the second volume. At the end of the fusion shot actuator 105 pushes the rod backward, to close hole 111. For clarity, only one shutter rod 112 was shown in FIG. 5. It is to be understood that each hole 111 has its respective shutter rod 112, so a plurality of shutter rods 112 close a plurality of passage hole 111 and are driven by a plurality of actuators 105. For cylindrical symmetrical configuration of holes 111, all shutter rods must be operated simultaneously by actuators 105. Asymmetrical holes configuration may be compensated by shutters timings to create a cylindrically uniform compression. According to another aspect of the invention, the selected timing of actuating the shutters can be used to create the desired flow pattern varying in the axial direction, for example, advancing the flow at the ends of the barrier tube to provide some closing of the ends of the second volume during the compression.

If pressure forces on shutter rod are balanced, namely As=Ae, the resistance force to movement of the rod is composed of liquid-rod friction and friction of sealing 115. Sealing 115 may be O-ring in a grove, or another sealing known in the art which create minimal friction even at high pressure. Sealing of holes 111 by rods 112 must withstand the very high pressure difference between the first and the second volumes.

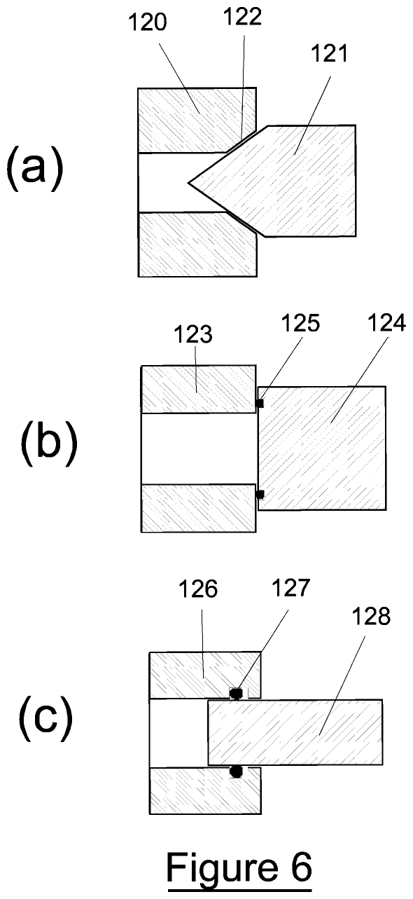

Examples of possible sealing configurations are given in FIG. 6. In (a) a conical sealing is depicted. A section 120 of a barrier tube 110 is shown, including a hole with conical section 122. Rod 121 has a matching conical section that provide the sealing. In (b), face sealing is described schematically. O-ring seal 125 or any other seal known in the art can be used. In (c) is, cylindrical sealing is depicted. Rod 128 is sealed to tube 126 by O-ring 127 or by any other known in the art seal. Face and conical sealing require significant tightening force but has the advantage of no seal friction upon release. A small outward movement of the rod will allow high-pressure liquid passage. Once the area, As enclosed by the sealing contour, is exposed to the pressure of the liquid, said pressure exerts an additional force on the rod directed to the outside (opening) direction, contributing to the outward pulling force exerted by actuator 105. The end of the rod at the barrier side can be configured to shape the flow pattern; for example a conical section can be added to rod 121 end. Cylindrical sealing requires no force for sealing, however, seal 127 adds friction force.

There is no limit on the radius R of the barrier tube 110 and the tube length. As explained above, there is an advantage to use larger R. The following is a numeral illustration.

Assume R1=30 cm, R2=35 cm, length d=300 cm, keeping d/R₁=10. With a tube made of high strength steel host liquid pressure can be selected as 1 GPa. PV potential energy per cm length is 2.8 MJ per cm length, 840 MJ for a 3 meter length of the tube.

### Fusionable Material Handling

The fusionable material may be any mixture of light nuclei, for example, Hydrogen ¹H, Deuterium ²H, Tritium ³H, Helium ³He. It can be in gas phase, liquid phase or embedded in a solid matrix. Other materials can be added to enhance plasma formation and/or the fusion process.

This invention discloses the application of a barrier between a first volume which is a high pressure volume filled by a liquid to a second volume, initially a low pressure volume. The fusionable material is inserted into the second, low pressure volume. The barrier is at least partially removed or transformed to liquid or opened in any other way to become penetrable and allow liquid flow from the first volume to the second volume allowing the liquid to compress the content of the second volume and create hot and dense plasma. According to the invention, there are various ways of delivering and enclosing the fusionable materials into the second volume. Few possible configurations are disclosed below. It is to be understood that the invention is not limited to these configurations.

### Configuration 1

In the simplest embodiment the second volume is filled with the fusionable material in gas phase. The pressure can be selected according to two criteria: (1) Divide the total available energy by the number of atoms (for diatomic molecules count 2 atoms), and make sure the energy per atom is above 1 keV or above 10 keV, or above another value depending on the fusion reaction cross section. The available energy is the sum of the mechanical—of the host liquid and any other form of energy which can be added to the fusionable material before or after the onset of the mechanical compression. (2) The density of the plasma at compression times the time of compression must be larger than the Lawson criterion calculated for the fusionable material at the plasma temperature.

As an example, follow the parameters of example 1. Assume only the mechanical energy is available, calculated above as 30 kJ per 1 cm length. One would like to have 10 keV per atom, which is 1.6×10⁻¹⁵ J. Dividing, we get 30×10³/1.6×10⁻¹⁵=18.8×10¹⁸ atoms. The volume of the inside of the R=6 cm tube for 1 cm length is 113 cm³, so the maximum density of atoms is 0.17×10¹⁸ cm⁻³. Since Deuterium and Tritium are diatomic molecules, the maximum density is 0.83×10¹⁷ cm³. This number corresponds to a pressure of 2.3 Torr at room temperature. Next, assume that during the compression, the radius diminishes from the initial R=6 cm up to 2 mm, radius compression ratio of 30 and volume compression of 900, increasing atomic density to 0.17×900×10¹⁸ cm⁻³=1.5×10²⁰ cm⁻³=1.5×10²⁶ m⁻³. For D-T fusion material, minimal confinement time of 1 (one) microsecond is required to exceed the Lawson criterion.

An advantage of the present invention is that the pressure of the host liquid continues for a long time, and does not drop quickly as in prior art based on pulse compression of the host liquid or pressure wave or shock wave driven in the host liquid. Therefore, one may expect few compression-expansion oscillations, similar to bubbles oscillation during periodic cavitations. When energy is gained from the fusion reaction, it will drive these oscillations stronger. The host liquid plays the role of a “spring” providing the restoring force.

### Configuration 2

Fusionable material which was driven to high energy, is injected into the second volume. It can be injected axially from at least one end of the barrier tube. For example, fusionable gas can be heated and/or ionized to hot plasma state by various means, such as electrical currents, RF, microwaves beams, or by lasers. Methods of generation of hot plasma are well known in the art, and therefore no need to detail them here. Said plasma can be generated in a third volume, outside of the barrier tube, or created inside the barrier tube. There are few options for the timing of the process.

(1) First inject the fusionable gas into the second volume; then apply at least one energy source on this material to generate hot plasma; then open the barrier for the pressurized liquid flow from the first volume into the second volume; (2) generate the plasma elsewhere, in a third volume outside the barrier tube; then inject it into the second volume; then open the barrier for the pressurized liquid flow from the first volume into the second volume.

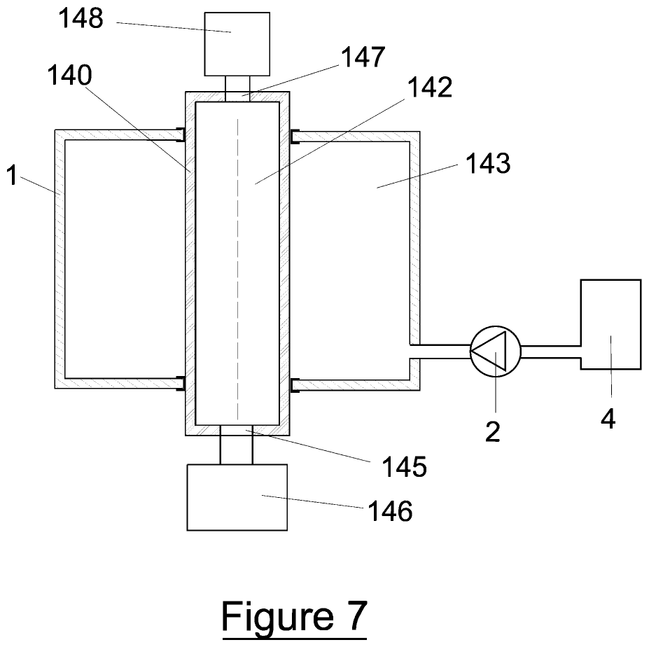

FIG. 7 discloses an example of these configurations. High-pressure tank 1 encloses from the outside the first volume 143. This volume is bounded internally by a barrier 140. Barrier 140 is the external boundary of the second volume 142. Said barrier is shown in this figure schematically, without the means for making it penetrable to the host liquid disclosed above. Pump 2 compress the liquid from reservoir 4 into the first volume 143, creating there very high pressure. Barrier 140 is a cylindrical tube, having at least one opening at the end. In FIG. 7 the openings are 145 and 146. Through at least one of said openings fusionable gas or liquid can be delivered into the second volume 142 from injectors 146 and/or 148. These injectors may include pressure vessels with fusionable material and valves (not shown in FIG. 7). Injectors 146 and/or 148 may further include means for plasma generation and compression in the fusionable material. Means for plasma generation of any kind may be used, as well known in the art, and will not be detailed here. This plasma is injected into volume 142. Injectors 146 and/or 148 may include means for delivering energy into volume 142 which create hot plasma in the gas injected into this volume and/or add energy to the plasma injected to or generated in said volume.

### Configuration 3

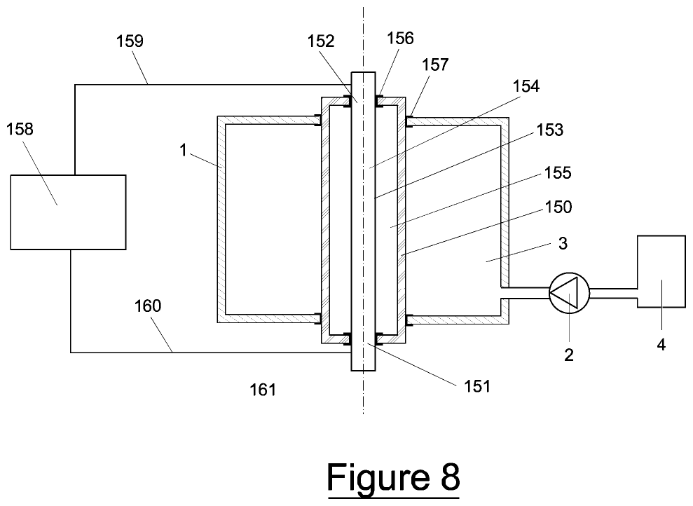

The fusionable material can be confined to a volume smaller than the second volume. The confinement can be done by any material which can hold the fusionable material stable inside the second volume until the liberation of compressing energy starts by making the barrier at least partially open for host liquid flow. The fusionable material can be in gas phase or in liquid phase, or embedded in a solid matrix. Refer to FIG. 8. The details of the solid barrier and means for making it penetrable are not shown in this figure, which is focused on the disclosed fusionable material handling. The important disclosed feature is enclosure 153, which is filled with fusionable material 154. This enclosure is inserted into the barrier tube 150 through at least one opening, 151 and/or 152. Sealing 156 is applied in these openings, also may serve as electrical insulator to enable current drive through tube 153.

The rest of the second volume, namely, the part not occupied by the enclosed fusionable material, depicted as numeral 155, can be kept in vacuum or filled with a gas at a pressure lower than the host liquid pressure compressed at the first volume 3. Obviously, it is advantageous to keep the cylindrical symmetry, since symmetrical compression increases the achieved density. Therefore, the fusionable material enclosure is preferably a tube, coaxial with the tube of the barrier of the host liquid as shown by center line 161.

The gas filling of volume 155 can be named “buffer”, in the sense that it matches the external pressure of the host liquid to the enclosure of the fusionable material. Proper selection of gas or gas mixture and pressure can optimize the compression. As an example, the gas may be selected from the group of noble gases, such as He, Ne, Ar. Also, fusionable gas such as hydrogen of deuterium may be included, so in the compression phase fusion reaction may occur in also this buffer gas. Another example is water vapor, provided keeping the temperature above the boiling temperature of water at the selected pressure. Heavy water vapor, D₂O may also be used. According to the invention, this buffer gas filling must be at a pressure lower than the pressure of the liquid in the first volume. It must be at least 10 (ten) times lower, better lower than 100 times lower, so that upon opening the barrier said liquid can gain high inward velocity before being decelerated by the compressed buffer gas. An advantage of this configuration is that during the compression phase by the liquid this buffer gas equalizes the pressure on the enclosure 153, therefore, improving the compression symmetry and uniformity. The gas has low inertia compared to the liquid, so the forces on the enclosure are substantially driven by the gas pressure.

According to the invention, the enclosure of the fusionable material 153 can be made of a material that will flow when the host liquid is liberated to flow inwardly. A possible configuration is to build this enclosure from a thin metal tube or another conducting material. In the art such a tube is called “liner”. This liner can be heated and transformed to liquid by driving through it a large current pulse. The current pulse can be driven by pulse generator 158 through conductors 159, 160. The timing of this pulse is synchronized with the timing of opening barrier 150, so that when the pressure inside the second volume rises to a certain level, the enclosing material can flow and compress the enclosed fusionable material.

An advantage of driving large current through the fusionable material enclosure 153, (the liner), is the generation of magnetic compression on the liner and the contained fusionable material. Current can be driven into the liner before, during and/or after the mechanical compression by the host liquid, thus adding magnetic compression and confinement to the fusionable material plasma. It is to be understood that any liner material and size and any electrical current pulse can be used according to the invention, and the details given below are only an example. The enclosure can be made of Lead-Lithium alloy, with 17% Lithium. The melting temperature of this alloy is 235 degrees C., the density of 10.22 g/cm³, the heat capacity of 0.15 J/g/K, and the latent heat of fusion 34 J/g. Since it is located in a low-pressure volume, 0.5 mm thickness of the wall tube is sufficient by strength considerations. Take as an example a tube radius of 10 mm. The mass per cm length is 3.2 g. Assume an initial temperature of 35 degrees C., so increase of 200 degrees C. is required for melting. The energy required for heating is 0.15×3.2×200=96 J per cm length. To this added 109 J per cm length of latent heat, making a total of 205 J per cm length for a complete transformation to a liquid phase. For a 50 cm tube, the energy required is about 10 kJ. The resistivity of this alloy changes with temperature, an average of 15×10⁻⁶ Ohm*cm is taken. The average resistance per cm length is 4.8×10⁻⁵ Ohm. Current pulse of approximately 400 kA and a length of 30 μsec will bring the Li—Pb tube to the liquid phase. The magnetic compression pressure of this current is approximately 1 GPa (10 kBar), which combines with the mechanical pressure of the host liquid to form hot dense plasma useful for the initiation of fusion reactions.

The buffer gas filling volume 155 may also contain fusionable material. The advantage is that it can contribute to the fusion reactions. The process can be expected to be as follows: Once the fusionable material in the enclosure generates energy by fusion reactions, this energy generates heat and pressure on the buffer gas. Since the buffer gas is surrounded and compressed by high pressure liquid, it is compressed and heated, hot plasma is generated and fusion reactions starts delivering more energy.

It is to be understood that the above configurations are examples of possible embodiments according to the invention. According to the invention a multi-layer cylindrical coaxial structures may be applied inside the second volume, and additional energy sources may be applied for confinement and heating of the plasma of the fusionable material.

### Fusion Reactor

An object of the invention is to generate fusion energy for use in power plants based, at least partially, on the mechanical potential energy stored in a liquid under very high static or quasi-static pressure. The fast release of this energy into a volume containing fusionable material produces hot plasma and compresses this plasma to high density.

Other energy sources can be added to enhance plasma temperature and density.

The invention discloses a fusion reactor for energy generation including:
a. a high-pressure tank defining the external boundary of at least part of a first volume;
b. a solid barrier defining at least part of the boundary between the first volume and a second volume;
c. liquid in a reservoir;
d. at least one pump configured to deliver said liquid from said reservoir into the first volume and to compress it to a high pressure in the first volume;
e. fusionable material filling at least part of the second volume;
f. means configured to make said solid barrier penetrable to liquid, allowing liquid flow from the first volume into the second volume.

The barrier can have spherical or cylindrical symmetry.

The means configured to make the barrier penetrable may include but are not limited to: At least one energy source configured to liquefy at least part of the barrier.

At least one pulsed power generator configured to drive electrical current through conductors embedded in and/or adjacent to said barrier.

Means configured to make the solid barrier penetrable to liquid by ignition of a chemical reaction.

According to an aspect of the invention, the barrier can be composed of a solid supporting structure, said supporting structure has plurality of holes (openings), said holes are covered by a layer of solid material. This layer of solid material can be covered by a film of material capable of exothermic reaction with the liquid.

According to another aspect of the invention, the solid barrier comprises a fixed solid part having at least one hole (opening) connecting the first volume to the second volume; at least one shutter configured to block said hole to liquid flow; at least one actuator configured to move the shutter to allow or block liquid flow. Said shutter can include a rod extending out of the high-pressure tank. Sealing area can be matched to the exit area of the rod out of the high pressure tank such as to control the force on the shutter. According to an aspect of the invention, a plurality of holes and their respective shutters are arranged in a cylindrical symmetry, said shutters are connected to a plurality of actuators, said actuators are configured to operate simultaneously.

In addition, an electrical pulsed power generator can be configured to drive current though the fusionable material and/or through the barrier to provide additional heat and compression to the fusionable material.

An optional way, according to the invention, of inserting fusionable material into the first volume is encapsulated in a solid container having a volume smaller than the second volume. Said container can be a cylindrical tube made of electrically conductive material. A pulsed power generator is configured to drive current through said tube of sufficient intensity for transforming it to a liquid phase so it can flow when the compression of the host liquid arrives. The fusion reactor may include various supporting systems which are known in the art.

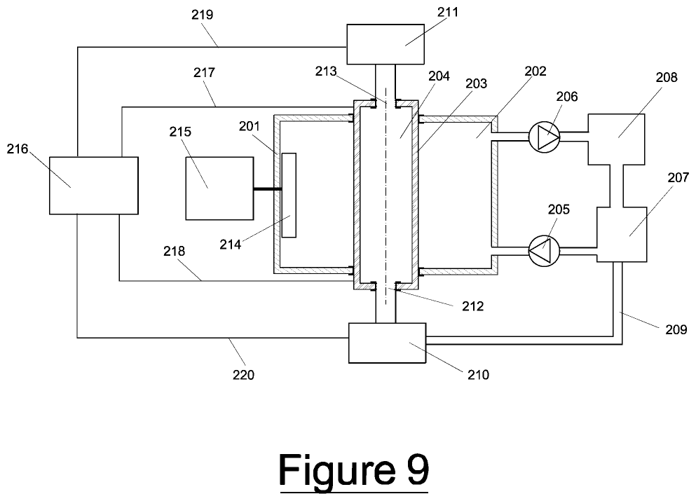

An example of a fusion reactor including the novel features according to the invention together with auxiliary supporting systems is depicted in FIG. 9.

A high-pressure tank 201 enclosing a first volume 202. The solid barrier 203 in this example has cylindrical symmetry and extends out of tank 201 at least at one end. Solid barrier 203 constitutes the internal boundary of the first volume 202 and the external boundary of a second volume 204. The liquid handling system includes a reservoir 207, pumps 205 and 206 and heat exchanger 208. Also included are various valves and sensors (not explicitly shown in FIG. 9 to avoid unnecessary complexity). Said pumps can move the liquid in and out of the first volume and circulate it through the heat exchanger 208. Pump 205 can drive very high liquid pressure in the first volume 202. This pump can be configured to drive the liquid in the first volume to a pressure above 10 MPa (100 Bar), or above 100 MPa (1 kBar) or above 1 GPa (10 kBar). Heat exchanger 208 can heat the liquid to a desired temperature required for the operation of the compression shot and/or take out extra heat from the liquid. When a fusion reaction is active and generates heat, this heat exchanger can transform the generated heat to another form of energy, such as electrical energy. Heat exchanger 208 may include liquid filters. Systems 210 and 211 include means for handling the fusionable material, the liquid arriving there after opening the barrier, and various auxiliary materials. Auxiliary systems may include means for transforming the solid barrier 203 to be penetrable to the liquid. These means may include, but are not limited to, energy radiating source 214 driven by power source 215, and/or pulse power system 216 capable of driving current pulse through the solid barrier 203 via conductors 217 and 218. These means may include actuators configured to drive shutters to close (block) or open (allow) liquid flow through the barrier (shown in FIG. 5, numeral 105). For the reasons explained above, the opening of the barrier must be fast. Therefore the barrier and the means for making the barrier penetrable to liquid are preferably configured to do it within 10 milliseconds or within 1 millisecond or within 100 microseconds.

Power system 216 may include options for driving energy through the plurality of conductors 219,220 for various actions, including but not limited to: (1) Preheating and plasma generation and compression in the fusionable material; (2) Melting of enclosure of fusionable material (not shown); (3) Driving current through the plasma generated in the second volume 204 for further heating and compression by the magnetic field.

The fusion reactor may include a command and control system which include sensors, processors, and command logic to handle the operation of the reactor. It is not shown in FIG. 9 to reduce complexity and is not detailed here since it is standard technology.

The method of operation of a fusion shot in the reactor according to the invention includes but not limited to:
inserting a solid barrier into a high pressure tank, constituting a boundary between a first volume and a second volume;
pumping liquid into the first volume and driving it to a high pressure; inserting fusionable material into the second volume;
applying means for making said solid barrier penetrable to liquid to allow liquid flow from the first volume into the second volume.

The method may also include:
Ignition of chemical reaction for making the barrier penetrable to liquid;
Moving simultaneously a plurality of shutters to allow liquid flow from the first volume into the second volume.
Driving current through the fusionable material and/or through the barrier to provide additional heating and compression force, which can be done before, during or after the barrier transformation to be penetrable to liquid flow.

Fusionable material can be inserted into the second volume as gas.

Following the insertion of the fusionable material into the second volume energy can be delivered to make said material a plasma.

Another option is that the fusionable material is driven to a plasma state before insertion into the second volume.

Also electrical current can be driven through the plasma formed in the second volume after the barrier is opened for liquid flow to provide additional heating and/compression.

According to an aspect of the invention, a liner encapsulating fusionable material is inserted into the second volume. Electrical current is driven through the liner to melt it. This current driving and melting can be done time matched to the opening of the barrier to liquid flow, so that when the liquid pressure arrives at the liner it can flow. Additional current can be driven through the liner to compress it by the magnetic force, so enhancing the confining and compressive pressure on the plasma of the fusionable material.

The operations involved in launching fusion shots in a fusion reactor include but are not limited to:
(1) Inserting the barrier into the high-pressure tank or closing the openings of a barrier already inserted;
(2) Pumping liquid into the first volume and compressing it to high quasi-static pressure;
(3) Inserting fusionable material into the second volume (also can be done before liquid pumping);
(4) Optionally: Delivering energy into the fusionable material to create a plasma;
(5) Optionally: Driving current through the fusionable material and/or through its enclosure to create magnetic compression;
(6) Opening the barrier to allow liquid flow from the first volume into the second volume to heat and compress the fusionable material to create hot and dense plasma;
(7) Optionally: Driving current through the fusionable material and/or through its enclosure for additional heating and/or compression;
(8) After the plasma decays, close the barrier openings (if possible) or remove it and insert a new barrier;
(9) Pump the liquid out of the second volume and of the auxiliary systems;
(10) Repeat the process.

Each fusion shot may be followed by auxiliary processes, including but not limited to: Charging all pulse generators and preparing them for the next shot; Circulating the liquid through heat exchanger to take the generated energy out and for filtering debris out of the liquid.

The invention claimed is:

1. A fusion reactor, including:
a high pressure tank defining the external boundary of at least part of a first volume;
a solid barrier defining at least part of the boundary between the first volume and a second volume;
liquid in a reservoir;
at least one pump configured to deliver said liquid from said reservoir into the first volume and to compress it to a pressure above 10 MPa in the first volume;
fusionable material filling at least part of the second volume;
means configured to make said solid barrier penetrable to liquid, allowing liquid flow from the first volume into the second volume.

2. A method for generation of nuclear fusion including:
inserting a solid barrier into a high pressure tank, constituting a boundary between a first volume and a second volume;
pumping liquid into the first volume and driving it to a pressure above 10 MPa;
inserting fusionable material into the second volume;
applying means for making said solid barrier penetrable to liquid to allow liquid flow from the first volume into the second volume.

3. A fusion reactor as in claim 1, where the solid barrier has spherical symmetry.

4. A fusion reactor as in claim 1, where the solid barrier has cylindrical symmetry.

5. A fusion reactor as in claim 1, where the means configured to make the solid barrier penetrable include at least one energy source configured to liquefy at least part of the barrier.

6. A fusion reactor as in claim 5, where at least one energy source is pulsed power generator configured to drive electrical current through conductors embedded in and/or adjacent to said barrier.

7. A fusion reactor as in claim 1, where the means configured to make the solid barrier penetrable to liquid include ignition of a chemical reaction.

8. A fusion reactor as in claim 1, where the barrier is composed of a solid supporting structure, said supporting structure has plurality of holes, said holes are covered by a layer of solid material.

9. A fusion reactor as in claim 8, where the layer of solid material is covered by a film of material capable of exothermic reaction with the liquid.

10. A fusion reactor as in claim 1, where the solid barrier comprises a fixed solid part having at least one hole connecting the first volume to the second volume; at least one shutter configured to block said hole to liquid flow; at least one actuator configured to move the shutter to allow or block liquid flow.

11. A fusion reactor as in claim 10, where said shutter includes a rod extending out of the high pressure tank.

12. A fusion reactor as in claim 11, where said shutter has fluid sealing area matched to the exit area of the rod out of the high pressure tank such as to control the force acting on the shutter.

13. A fusion reactor according to claim 10, where a plurality of holes and their respective shutters are arranged in a cylindrical symmetry, said shutters are connected to a plurality of actuators, said actuators are configured to operate simultaneously.

14. A fusion reactor as in claim 1, further including an electrical pulsed power generator configured to drive current though the fusionable material and/or through the barrier to provide additional heat and compression to the fusionable material.

15. A fusion reactor as in claim 1, where the fusionable material is encapsulated in a solid container having a volume smaller than the second volume.

16. A fusion reactor as in claim 15, where said container is a cylindrical tube made of electrically conductive material.

17. A fusion reactor as in claim 16, further including a pulsed power generator configured to drive current through said tube of sufficient intensity for transforming it to a liquid phase.

18. (canceled)

19. A fusion reactor as in claim 1, where the pump is configured to drive the liquid to pressure above 100 MPa.

20. A fusion reactor as in claim 1, where the means for making the barrier penetrable are configured to do it within 10 milliseconds.

21. A fusion reactor as in claim 1, where the means for making the barrier penetrable are configured to do it within 1 millisecond.

22. A method as in claim 2, further including ignition of chemical reaction for making the barrier penetrable to liquid.

23. A method as in claim 2, further including moving simultaneously a plurality of shutters to allow liquid flow from the first volume into the second volume.

24. A method as in claim 2, further including driving current through the fusionable material and/or through the barrier to provide additional heating and compression force.

25. A method as in claim 2, where the fusionable material is inserted into the second volume as gas.

26. A method as in claim 2, where following the insertion of the fusionable material into the second volume energy is delivered to make said material a plasma.

27. A method as in claim 2, where the fusionable material is driven to a plasma state before insertion into the second volume.

28. A method as in claim 2, where electrical current is driven through the plasma formed in the second volume after the barrier is opened for liquid flow to provide additional heating and/or compression.

29. A method as in claim 2, where a liner encapsulating fusionable material is inserted into the second volume.

30. A method as in claim 29, where electrical current is driven through the liner to melt it.

31. A method as in claim 29, where electrical current is driven through the liner to compress it.
